(19) United States
(12) Patent Application Publication
(10) Pub. No.: US 2021/0110442 A1
(43) Pub. Date: Apr. 15, 2021

(54) TERMINAL DISPLAY METHOD, TERMINAL, COMPUTER-READABLE STORAGE MEDIUM INCLUDING TERMINAL PROGRAM, SERVER COMMUNICATION METHOD, SERVER, AND COMPUTER-READABLE STORAGE MEDIUM INCLUDING SERVER PROGRAM

(71) Applicant: LINE Corporation, Tokyo (JP)

(72) Inventors: Shouji Fujiwara, Tokyo (JP); Masaki Kunikyo, Tokyo (JP)

(73) Assignee: LINE Corporation, Tokyo (JP)

(21) Appl. No.: 17/128,477

(22) Filed: Dec. 21, 2020

Related U.S. Application Data
(63) Continuation of application No. PCT/JP2018/041409, filed on Nov. 7, 2018.

(30) Foreign Application Priority Data
Sep. 25, 2018 (JP) 2018-179568

(51) Int. Cl. G06Q 30/02; G06Q 20/32

(52) U.S. Cl. CPC G06Q 30/0281; G06Q 30/0282; G06Q 20/3255

(57) ABSTRACT

A display method for a user terminal including a processor and configured to transmit/receive information to/from a server including transmitting, by the user terminal, first information including information about the user to the server, receiving candidate information relating to at least one candidate company that is based on the first information, and evaluation information relating to an evaluation of the at least one candidate company from the server, and displaying, on a display region of the terminal, the candidate information based on the evaluation information may be provided.

### CROSS-REFERENCE TO RELATED APPLICATIONS

This U.S. non-provisional application is a continuation of and claims the benefit of priority under 35 U.S.C. § 365(c) to International Application PCT/JP2018/041409, which has an International filing date of Nov. 7, 2018 and claims priority to Japanese Patent Application No. 2018-179568, filed Sep. 25, 2018, the entire contents of each of which are incorporated herein by reference in their entirety.

### BACKGROUND

### Field

The present disclosure relates to methods for displaying information relating to a plurality of business contacts on a terminal.

### Description of Related Art

In recent years, there have been increasing opportunities in which a customer and a service-providing company conduct communications and transactions via a messaging service.

### SUMMARY

According to an example embodiment of the present disclosure, a display method for a user terminal including a processor and configured to transmit/receive information to/from a server includes transmitting, by the terminal, first information including information about the user to the server, receiving, by the terminal, candidate information relating to at least one candidate company that is based on the first information and evaluation information relating to an evaluation of the at least one candidate company from the server, and displaying, on a display region of the terminal, the candidate information based on the evaluation information.

According to an example embodiment of the present disclosure, a user terminal configured to transmit/receive information to/from a server includes a memory configured to a program and one or more processors configured to execute the program such that the one or more processors are configured to cause the terminal to transmit first information including information about the user to the server, and receive candidate information relating to at least one candidate company that is based on the first information, and evaluation information relating to an evaluation of the at least one candidate company from the server, and a display configured to display the candidate information based on the evaluation information.

According to an example embodiment of the present disclosure, a non-transitory computer readable medium storing a program that, when executed by a processor, causes a terminal including the processor and configured to transmit/receive information to/from a server to perform a display method, which comprises transmitting first information including information about the user to the server, receiving, by the terminal, candidate information relating to at least one candidate company that is based on the first information, and evaluation information relating to an evaluation of the at least one candidate company from the server, and displaying, on a display region of the terminal, the candidate information based on the evaluation information.

According to an example embodiment of the present disclosure, a communication method for a server configured to transmit/receive information to/from a user terminal includes receiving first information including information about the user from the terminal from a terminal of a user, and transmitting information relating to at least one candidate company based on the first information to the terminal, and evaluation information relating to an evaluation of the at least one candidate company.

According to an example embodiment of the present disclosure, a server configured to transmit/receive information to/from a user terminal includes a memory configured to a program and one or more processors configured to execute the program such that the one or more processors are configured to cause the terminal to receive first information including information about the user from the terminal, and to transmit information relating to at least one candidate company that is based on the first information and evaluation information relating to an evaluation of the at least one candidate company, to the terminal.

According to an example embodiment of the present disclosure, a non-transitory computer readable medium storing a program that, when executed by a computer of a server, configures the server to transmit/receive information to/from a user terminal is provided. The program, when executed by a processor of the server, causes the computer to receive first information including information about the user from the terminal, and transmit information relating to at least one candidate company that is based on the first information and evaluation information relating to an evaluation of the at least one candidate company, to the terminal.

### BRIEF DESCRIPTION OF THE DRAWINGS

FIG. 1 is a diagram illustrating a configuration of a communication system in an example embodiment.

FIG. 2 is a conceptual data diagram illustrating a configuration example of user information.

FIG. 3 is a conceptual data diagram illustrating a configuration example of request information.

FIG. 4 is a conceptual data diagram illustrating a configuration example of request information in a state where detailes have been disclosed.

FIG. 5 is a sequence diagram illustrating an example of interactions between devices in a communication system up to when an estimate is transmitted to a terminal.

FIG. 6 is a flowchart illustrating an operation example of a terminal for achieving the interactions of FIG. 5.

FIG. 7 is a flowchart illustrating an operation example of a server for achieving the interactions of FIG. 5.

FIG. 8 is a flowchart illustrating an operation example of a company server for achieving the interactions of FIG. 5.

FIG. 9A is a diagram of a screen of a terminal, illustrating an example of when the terminal requests for an estimate. FIG. 9B is a diagram of a screen of a terminal, illustrating an example of a Talkroom with a server. FIG. 9C is a diagram of a screen of a terminal, illustrating an example showing a list of Talkrooms.

FIG. 10A is a diagram of a screen of a terminal, illustrating an example of a Talkroom with a company server. FIG. 10B is a diagram of a screen of a terminal, illustrating an example of a Talkroom with a server. FIG. 10C is a diagram of a screen of a terminal, illustrating a list of Talkrooms, with some Talkrooms deleted.

FIG. 11A is a diagram of a screen of a terminal, illustrating an example of a rich menu. FIG. 11B is a diagram of a screen of a terminal, illustrating an example of a transaction with a company server by using a negotiation image.

FIG. 12A is an example of a screen illustrating a Talkroom with a server, and is a diagram of a screen illustrating an example of an evaluation of a person in charge.

FIG. 12B is a diagram of a screen illustrating an example for indicating a company recommended to a user.

FIG. 13 is a sequence diagram illustrating an example of interactions between devices in a communication system up to when a reward is transmitted to a terminal.

FIG. 14 is a flowchart illustrating an operation example of a server for achieving the interactions of FIG. 13.

FIG. 15 is a flowchart illustrating an operation example of a terminal for achieving the interactions of FIG. 13.

FIGS. 16A and 16B are diagrams of a screen of a terminal, illustrating examples of transmitting billing amount information from a terminal to a server.

FIG. 17 is a flowchart illustrating another operation example of when a server transmits an estimate to a terminal.

FIG. 18 is a diagram of a screen of a terminal, illustrating an example of when estimates are transmitted collectively from a server to a terminal.

FIG. 19 is a diagram illustrating an example of request information indicating recommended users.

FIGS. 20A and 20B are diagrams of a screen, illustrating examples of a Talkroom indicating a recommended user.

FIG. 21 is a conceptual data diagram illustrating a configuration example of company information.

FIG. 22 is a sequence diagram, illustrating an example of interactions for when a server executes matching between a user and a company.

FIG. 23 is a flowchart illustrating an operation example of a server when executing matching between a user and a company.

FIGS. 24A and 24B are conceptual diagrams illustrating examples of a relationship between two requests when subjected to matching.

FIGS. 25A and 25B are diagrams of a screen of a company server, illustrating examples for when a specific user is recommended when a server sends a request to a company server.

FIG. 26A is a block diagram illustrating another configuration example of a terminal. FIG. 26B is a block diagram illustrating another configuration example of a server. FIG. 26C is a block diagram illustrating another configuration example of a company server.

### DETAILED DESCRIPTION

{Compliance with Legal Requirements}

It should be noted that the disclosure provided herein is premised on compliance with legal requirements, such as secrecy of communication, that need to be observed in a country in which the present disclosure is to be implemented.

Some example embodiments for implementing display methods according to the present disclosure for making a terminal display an evaluation of a business contact will be described below with reference to the drawings.

### {System Configuration}

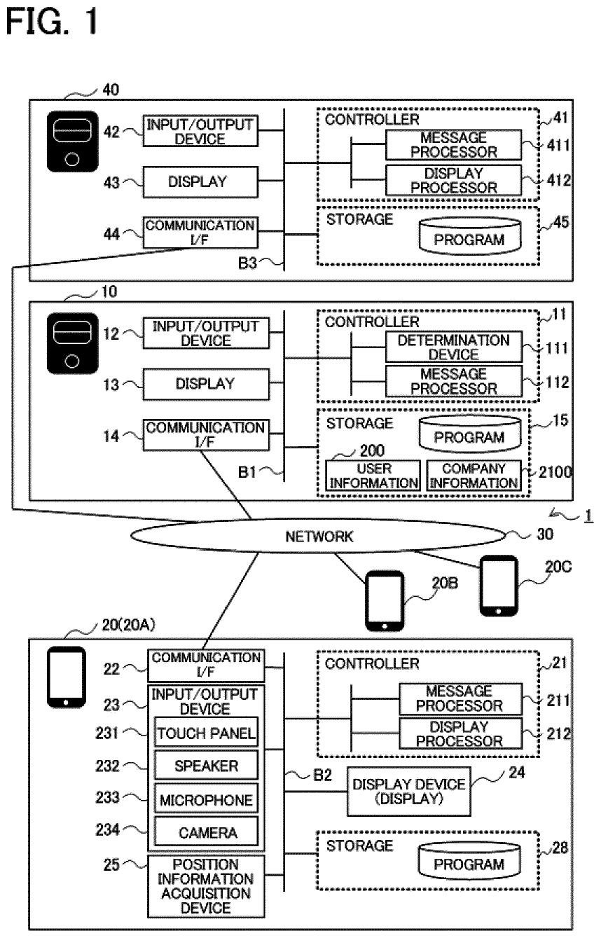

FIG. 1 illustrates a configuration of a communication system 1 according to an example embodiment of the present disclosure. As disclosed in FIG. 1, the communication system 1 includes a server 10, terminals 20 (terminal 20A, terminal 20B, and terminal 20C), and a company server 40 which are connected to each other via a network 30. The server 10 provides, via the network 30 to the terminals 20 owned by respective users, a service for allowing the terminals 20 (as well as the company server 40) to transmit and receive message(s) with one another. The number of terminals 20 to be connected to the network 30 is not limited.

The network 30 serves to connect one or more of the terminals 20 to one or more of the servers 10. That is, the network 30 serves as a communication network that provides a connection path to enable the terminal(s) 20, once connected to the server(s) 10, to transmit and receive data.

One or a plurality of portions of the network 30 may be a wired network or a wireless network. For example, without limitation, the network 30 may include one, or a combination of two or more, communication forms, such as an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a mobile phone network, integrated service digital networks (ISDNs), radio LANs, long term evolution (LTE), code division multiple access (CDMA), Bluetooth (registered trademark), or satellite communication. The network 30 may include one or a plurality of networks 30.

The terminals 20 (terminal 20A, terminal 20B, and terminal 20C) may each be any kind of terminal that is an information processing terminal capable of implementing functions described in some example embodiments. For example, without limitation, each of the terminals 20 may be a smartphone, a mobile phone (such as a feature phone), a computer (for example, without limitation, a desktop, a laptop, or a tablet), a media computer platform (for example, without limitation, cable TV, a satellite set-top box, or a digital video recorder), a handheld computer device (for example, without limitation, a personal digital assistant (PDA) or an electronic mail client), a wearable terminal (for example, without limitation, an eyeglasses-type device or a watch-type device), or any one of other types of computers and/or communication platforms. The terminal 20 may also be referred to as an information processing terminal.

The configuration of the terminals 20A, 20B, and 20C is the same or substantially similar to each other, so in the explanation below, the configuration of terminal 20 will be described. Where desired, a terminal used by user X will be referred to as terminal 20X, and user information in a desired (or alternatively, predetermined) service, being associated with user X or terminal 20X, will be referred to as user information X. The user information is information relating to a user associated with an account that is employed by the user in the desired (or alternatively, predetermined) service. For example, without limitation, the user information may include information inputted by the user, and/or information assigned by a desired (or alternatively, predetermined) service, and may include one or more pieces of information associated with the user, such as the user's name, an icon image of the user, user's age, user's gender, user's address, user's hobbies/preferences (or indication), or user's identifier.

The server 10 functions to provide a desired (or alternatively, predetermined) service to the terminal 20. The server 10 may be any information processing device capable of implementing functions described in some example embodiments. For example, without limitation, the server 10 may be a server device, a computer (e.g., without limitation, a desktop, a laptop, or a tablet), a media computer platform (e.g., without limitation, cable TV, a satellite set-top box, or a digital video recorder), a handheld computer device (e.g., without limitation, a PDA or an electronic mail client), or any one of other types of computers and/or communication platforms. The server 10 may also be referred to as an information processing device. In cases where the server 10 and the terminal 20 do not need to be distinguished from one another, both the server 10 and the terminal 20 may be referred to as an information processing device.

### {Hardware (HW) Configuration}

A hardware configuration of each device included in the communication system 1 will be described with reference to FIG. 1.

(1) HW Configuration of Terminal:

The terminal 20 includes a controller 21 (central processing unit; CPU), a storage 28, a communication interface (I/F) (alternatively referred to as communication interface circuitry) 22, an input/output device 23, a display 24, and a position information acquisition device 25. The input/output device may include a touch panel 231, a microphone 233, a speaker 232, and a camera 234. For example, without limitation, the constituent elements of the HW of the terminal 20 are interconnected via a bus B2. It should be noted that not all of the constituent elements need to be included in the HW configuration of the terminal 20. For example, without limitation, the terminal 20 may be configured such that one or more of the constituent elements, such as the microphone 233 or camera 234, can be removed.

The communication I/F 22 is configured to transmit and/or receive various data via the network 30. The communication may be carried out in a wired and/or wireless manner, and may be based on any communication protocol that enables mutual communication to be carried out. The communication I/F 22 functions to communicate with the server 10 via the network 30. The communication I/F 22 is configured to transmit various data to the server 10 in accordance with instructions from the controller 21. Further, the communication I/F 22 is configured to receive various data transmitted from the server 10 and convey the data to the controller 21. The communication I/F 22 may be referred to as a communication device. The communication I/F 22 may also be referred to as a communication circuit in cases where the communication I/F is constituted by a physically structured circuit. The communication I/F 22 may or may not communicate with the company server 40 via the network 30.

The input/output device 23 includes a device through which various operations to the terminal 20 are inputted, and a device from which processing results processed by the terminal 20 are outputted. In the input/output device 23, the input device and the output device may be integrated, or may or may not be separate from one another.

The input device may be implemented by any one of, or a combination of, all types of devices capable of accepting an input from a user and conveying information about the input to the controller 21. For example, without limitation, the input device may include a touch panel 231, a touch display, hardware keys such as a keyboard, a pointing device such as a mouse, a camera 234 (operation/input by a moving image), or a microphone 233 (operation/input by audio).

The output device may be implemented by any one of, or a combination of, all the types of devices capable of outputting a processing result from processing performed by the controller 21. For example, without limitation, the output device may include a touch panel, a touch display, a speaker 232 (audio output), a lens (for example, without limitation, three-dimensional (3D) output or hologram output), or a printer.

The display 24 may be implemented by any one of, or a combination of, all the types of devices capable of providing display in accordance with display data written in a frame buffer. For example, without limitation, the display 24 may include a touch panel, a touch display, a monitor (e.g., without limitation, a liquid crystal display or an organic electroluminescence display (OELD)), a head mounted display (HMD), projection mapping, a hologram, or a device capable of displaying an image or text information in the air (which may or may not be a vacuum). The display 24 may or may not be capable of displaying 3D display data.

In cases where the input/output device 23 is a touch panel, the input/output device 23 and the display 24 may have substantially the same size and shape, and be arranged opposing one another.

The controller 21 may be implemented by, for example, without limitation, a data processing device embedded in hardware and including a physically structured circuit for executing functions implemented by codes or commands included in a program. Thus, the controller 21 may or may not be referred to as a control circuit.

For example, without limitation, the controller 21 may include a central processing unit (CPU), a microprocessor, a processor core, a multiprocessor, an application-specific integrated circuit (ASIC), or a field programmable gate array (FPGA).

The storage 28 functions to store various programs and/or various data necessary for the terminal 20 to operate. For example, without limitation, the storage 28 may include one or more of various storage media, such as a hard disk drive (HDD), a solid state drive (SSD), a flash memory, a random access memory (RAM), a read only memory (ROM), and the like. The storage 28 may or may not be referred to as a memory.

The terminal 20 stores a program P in the storage 28. With the program P executed, the controller 21 carries out processing as the various units included in the controller 21. Stated differently, the program P stored in the storage 28 materializes various functions via implementation of the controller 21 in the terminal 20. The program P may or may not be referred to as a program module.

The microphone 233 may be used to input audio data. The speaker 232 may be used to output audio data. The camera 234 may be used to acquire moving image data.

(2) HW Configuration of Server:

The server 10 includes a controller (CPU) 11, a storage 15, a communication interface (I/F) 14, an input/output device 12, and a display 13. For example, without limitation, the constituent elements of the hardware (HW) of the server 10 are interconnected via a bus B1. Note that the HW of the server 10 does not necessarily have to include all the constituent elements as the configuration of the HW of the server 10. For example, without limitation, the HW of the server 10 may be configured such that the display 13 is removable.

The controller 11 may be implemented by, for example, without limitation, a data processing device embedded in hardware and including a physically structured circuit for executing functions implemented by codes or commands included in a program.

The controller 11 may be a central processing unit (CPU), or may be a microprocessor, a processor core, a multiprocessor, an ASIC, or a FPGA. In the present disclosure, the controller 11 is not limited to the above.

The storage 15 functions to store various programs and/or various data desired for the server 10 to operate. For example, the storage 15 may be implemented by one or more of various storage media, such as a HDD, a SSD, or a flash memory. In the present disclosure, the storage 15 is not limited to the above. The storage 15 may or may not be referred to as a memory.

The communication I/F 14 is configured to transmit and/or receive various data via the network 30. Communication may be carried out in a wired and/or wireless manner and may be based on any communication protocol that enables mutual communication to be carried out. The communication I/F 14 functions to communicate with the terminal 20 or the company server 40 via the network 30. The communication I/F 14 is configured to transmit various data to the terminal 20 or the company server 40 in accordance with instructions from the controller 11. Further, the communication I/F 14 is configured to receive various data transmitted from the terminal 20 or the company server 40 and convey the data to the controller 11. The communication I/F 14 may be referred to as a communication device. The communication I/F 14 may also be referred to as a communication circuit in cases where the communication I/F is constituted by a physically structured circuit.

The input/output device 12 may be implemented by a device through which various operations to the server 10 are inputted. The input/output device 12 may be implemented by any one of, or a combination of, all types of devices capable of accepting an input from a user and conveying information about the input to the controller 11. The input/output device 12 may be implemented by hardware keys such as a keyboard, or a pointing device such as a mouse. For example, without limitation, the input/output device 12 may include a touch panel, a camera (operation/input by a moving image), or a microphone (operation/input by audio). In the present disclosure, the input/output device 12 is not limited to the above.

The display 13 may be implemented by a monitor (for example, without limitation, a liquid crystal display or an organic electroluminescence display (OELD)). The display 13 may be a head mounted display (HMD). The display 13 may be capable of displaying 3D display data. In the present disclosure, the display 13 is not limited to the above.

The server 10 stores a program P in the storage 15. With the program P executed, the controller 11 carries out processing as the various units included in the controller 11. Stated differently, the program P stored in the storage 15 materializes various functions via implementation of the controller 11 within the server 10. The program P may or may not be referred to as a program module.

The company server 40 includes a controller (CPU) 41, a storage 45, a communication interface (I/F) 44, an input/output device 42, and a display 43. For example, without limitation, the constituent elements of the hardware (HW) of the company server 40 are interconnected via a bus B3. Note that the HW of the company server 40 does not necessarily have to include all the constituent elements as the configuration of the HW of the company server 40. For example, without limitation, the HW of the company server 40 may be configured such that the display 43 is removable.

The controller 41 may be implemented by, for example, without limitation, a data processing device embedded in hardware and including a physically structured circuit for executing functions implemented by codes or commands included in a program.

The controller 41 may be a central processing unit (CPU), or may be a microprocessor, a processor core, a multiprocessor, an ASIC, or a FPGA. In the present disclosure, the controller 41 is not limited to the above.

The storage 45 functions to store various programs and/or various data desired for the company server 40 to operate. For example, the storage 45 may be implemented by one or more of various storage media such as an HDD, an SSD, or a flash memory. In the present disclosure, the storage 45 is not limited to the above. The storage 45 may or may not be referred to as a memory.

The communication I/F 44 is configured to transmit and/or receive various data via the network 30. Communication may be carried out in a wired and/or wireless manner and may be based on any communication protocol that enables mutual communication to be carried out. The communication I/F 44 functions to communicate with the server 10 via the network 30. The communication I/F 44 is configured to transmit various data to the server 10 in accordance with instructions from the controller 41. Further, the communication I/F 44 is configured to receive various data transmitted from the server 10 and convey the data to the controller 41. The communication I/F 44 may be referred to as a communication device. The communication I/F 44 may also be referred to as a communication circuit in cases where the communication I/F is constituted by a physically structured circuit. The communication I/F 44 may or may not function to communicate with the terminal 20 via the network 30.

The input/output device 42 may be implemented by a device through which various operations to the company server 40 are inputted. The input/output device 42 may be implemented by any one of, or a combination of, devices capable of accepting an input from a user and conveying information about the input to the controller 41. The input/output device 42 may be implemented by hardware keys such as a keyboard, or a pointing device such as a mouse. For example, without limitation, the input/output device 42 may include a touch panel, a camera (operation/input by a moving image), or a microphone (operation/input by audio). In the present disclosure, the input/output device 42 is not limited to the above.

The display 43 may be implemented by a monitor (e.g., without limitation, a liquid crystal display or an organic electroluminescence display (OELD)). The display 43 may be a head mounted display (HMD). The display 43 may be capable of displaying 3D display data. In the present disclosure, the display 43 is not limited to the above.

Some example embodiments of the present disclosure are described as being implemented by the CPU of the terminal 20, the server 10 or the company server 40 executing a program P.

The controller 21 of the terminal 20, the controller 11 of the server 10, and/or the controller 41 of the company server 40 may implement various processes with, for example, a CPU having a control circuit, or with a dedicated circuit or a logic circuit (hardware) formed on, for example, an integrated circuit (IC) chip or a large-scale integration (LSI). These circuits may be implemented by one or a plurality of integrated circuits. A plurality of processes described in some example embodiments may or may not be implemented by a single integrated circuit. LSI may be referred to as, for example, VLSI, super LSI, or ultra LSI, depending on the degree of integration. The controller 21 may be referred to as a control circuit.

The programs P (e.g., without limitation, software programs, computer programs, and/or program modules) in some example embodiments of the present disclosure may be provided in a state where the programs are stored on a computer-readable storage medium, or may be provided in other forms. A storage medium is capable of storing a program P as a “non-transitory tangible medium”. The programs P according to the present disclosure may be for implementing some functions of the example embodiments. The program P according to the present disclosure may not be a program, but a file that is capable of achieving functions of the various example embodiments in combination with a program P already recorded on a storage medium.

The storage medium may include one of, or a suitable combination of two or more of, semiconductor-based or other integrated circuits (ICs) (e.g., without limitation, field programmable gate arrays (FPGAs) or application-specific integrated circuits (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid state drives (SSDs), RAM drives, Secure Digital cards, drives, and/or any other appropriate storage media. Where appropriate, the storage medium may include a volatile storage medium, a non-volatile storage medium, or a combination of volatile and non-volatile storage media. The storage medium is not limited to these examples and may be any device or medium that is capable of storing the program(s) P. The storage medium may or may not be referred to as a memory.

The server 10, the terminal 20, or the company server 40 may implement the functions of various functional units described in some example embodiments by reading out a program P stored in a storage medium and executing the program P.

The programs P according to the present disclosure may be provided to the server 10, the terminal 20, or the company server 40 via any transmission medium (e.g., without limitation, a communication network, broadcast waves, etc.) that is capable of transmitting the programs. For example, without limitation, the server 10, the terminal 20, or the company server 40 may implement the functions of various functional units described in some example embodiments by executing a program P downloaded via the Internet or the like.

Some example embodiments of the present disclosure may also be implemented in the form of a data signal that is embedded in a carrier wave and in which the program P is embodied by electronic transmission.

At least a portion of processes at the server 10, the terminal 20, or the company server 40 may be implemented by cloud computing constituted by one or more computers.

At least a portion of processes at the terminal 20 may be carried out by the server 10. In this case, the server 10 may or may not execute at least a portion of processes of the various functional units of the controller 21 of the terminal 20.

At least a portion of processes at the server 10 may or may not be carried out by the terminal 20. In this case, the terminal 20 may execute at least a portion of processes of the various functional units of the controller 11 of the server 10.

Configurations for determination in some example embodiments of the present disclosure are not essential unless explicitly mentioned otherwise, and a desired (or alternatively, predetermined) process may be activated in case a determination condition is satisfied, or a desired (or alternatively, predetermined) process may be activated in case a determination condition is not satisfied, although not limited thereto.

The programs according to the present disclosure may be implemented using, for example, without limitation, a script language such as ActionScript and/or JavaScript (registered trademark), an object-oriented programming language such as Objective-C and/or Java (registered trademark), or a markup language such as HTML5.

### Functional Configuration

### First Example Embodiment

In a communication system 1 according to a first example embodiment, a terminal 20 of a user transmits an estimate request to a server 10, and receives estimate information from respective company servers 40 via the server 10. In this operation, the server 10 transmits, to the user terminal 20, evaluation information of each of the company servers 40 providing the estimate. The terminal 20 displays the evaluation of each company server 40. Thus, the user can recognize objective evaluations of the respective company servers 40, and can thereby be prevented or protected from selecting a company that may provide a cheaper estimate than the actual price. In the description below, the terminal 20 and the company servers 40 use a messaging service provided by the server 10.

### (1) Functional Configuration of Terminal:

As illustrated in FIG. 1, the terminal 20 includes a message processor 211 and a display processor 212 as functions implemented by the controller 21.

In accordance with a messaging application provided in the messaging service provided by the server 10, the message processor 211 accepts an input from the user or an input of a message received by the communication I/F 22, and instructs the display processor 212 to display the input content. In cases where an input is accepted from the user, the message processor instructs the communication I/F 22 to transmit the accepted input content to the server 10.

The display processor 212 instructs the display 24 to display display information indicating contents of a Talkroom in accordance with an instruction from the message processor 211. In an example embodiment, in response to an estimate request from a user, the display processor 212 displays information that renders identifiable the company servers 40 that will process the estimate request transmitted from the server 10, as well as evaluation information indicating an evaluation of each of the company servers 40. Herein, the information that renders the company servers 40 identifiable may be displayed based on the evaluation information. “Displaying based on the evaluation information” may be, for example, without limitation, displaying in ascending or descending order by ratings as indicated by the evaluation information of the company servers 40, or may be displaying indicating evaluation (rating) values (e.g., numerical values, levels, or graphs) that straightforwardly indicate the evaluations (ratings) of the respective company servers 40, or displaying that allows highly evaluated company servers 40 to be distinguished relative to poorly evaluated company servers 40. The displaying method (e.g., a display mode) may be determined according to a setting made to the display processor 212 by the user in advance. In some example embodiments, the displaying method may be designated by the server 10. The display processor 212 may display information relating to interactions between the server 10 and the company servers 40 in association with the estimate request made by the terminal 20.

### (2) Functional Configuration of Server:

As illustrated in FIG. 1, the server 10 includes a determination device 111 and a message processor 112 as functions implemented by the controller 11. The storage 15 stores user information 200 indicating information about users, and company information 2100 indicating information about companies (company servers 40).

The message processor 112 includes a function to manage Talkrooms for allowing users to interact, and a function to analyze a message (e.g., an estimate request) transmitted from a terminal 20 of a user to a Talkroom and to transmit an estimate request to company servers 40 determined by the determination device 111. A “Talkroom” is a place where users (including company servers 40) using a messaging service provided by the server 10 can exchange messages via the messaging service. A “Talkroom” is a user interface wherein a message transmitted by a user participating in a certain Talkroom can be viewed by all users participating in that Talkroom. A Talkroom can be created by the server 10 or by a user (including a company server 40) using the messaging service. When a Talkroom is created, users associated with the Talkroom are enabled to transmit messages to that Talkroom. The user who created the Talkroom and/or users participating in the Talkroom can set the users who are allowed to transmit messages to the Talkroom. A user can leave a Talkroom at the user's discretion. The server 10 can also close a Talkroom as desired. In response to an estimate request from a user, the message processor 112 instructs the determination device 111 to determine at least one company server 40 to which the estimate request is to be transmitted in accordance with the estimate request. Further, information that there has been an estimate request (request information) is transmitted to the company servers 40 determined by the determination device 111. Details on the request information will be described further below. The message processor 112 transmits, to the terminal 20, information to the effect that estimates will be presented from a plurality of company servers 40 determined by the determination device 111, together with evaluation information about each of the company servers 40. The evaluation information could be stored in the storage 15 in advance. In cases where the evaluation information is not stored in the storage 15, it may be acquired from the network 30 or an external device. The evaluation information is information indicating an evaluation of each company server 40. The evaluation may be expressed by an objective numerical value, an indication of a level (e.g., a numerical value and/or a symbol), or text. For the evaluation information of each company server 40, it is possible to use data acquired by compiling evaluations about that company server 40 sent in from many users. The contents of evaluations in the evaluation information may be updated as appropriate. The evaluation information may be based on past accomplishments by the company server 40, or may be acquired by using past data, or may be acquired by using data within a desired (or alternatively, predetermined) period (e.g., without limitation, data within the past two years from present). The message processor 112 may have a function, in response to the user determining a company from which he/she will request service, to inform the user that a reward will be offered if the user provides information about the billing amount from that company. Further, in cases where the determination device 111 determines the company servers 40, to which the estimate request is to be transmitted, based on compatibility using the user information 200 and the company information 2100, the message processor 112 may transmit, to the terminal 20 and/or the company server 40, information recommending the other party on a Talkroom.

The determination device 111 has a function, based on the estimate request from the user terminal 20 (e.g., information provided from the user), to determine company servers 40 to which the estimate request is to be transmitted. For example, the determination device 111 may perform matching between the company servers 40 and the contents of the estimate request from the user. The determination device 111 may determine at least two company servers 40 as companies to which the estimate request is to be sent. Here, the determination device 111 may determine, based on the contents of the estimate request from the user, company servers 40 that seem good at handling the request, or that seem to have good compatibility with the user. In cases where the determination device 111 determines company servers 40 that seem to have good compatibility, the determination device 111 makes this determination by referencing the user information 200 and the company information 2100. In some example embodiments, the determination device 111 may, for example, randomly determine a desired (or alternatively, predetermined) number of company servers 40. A method for determining company servers 40 based on a correlation between the user and the companies will be described further below.

### (3) Functional Configuration of Company Server:

As illustrated in FIG. 1, the company server 40 includes a message processor 411 and a display processor 412 as functions implemented by the controller 41.

The message processor 411 has a function to process messages transmitted from the server 10 or the terminal 20 via the communication I/F 44. The message processor 411 makes the display processor 412 display information indicating that there is request information transmitted from the server 10, indicating the contents of an estimate from a user. The message processor 411 also has a function to transmit, to the server 10 from the communication I/F 44, information relating to an estimated amount, as inputted by an operator of the company server 40, in response to the estimate request indicated by the request information.

The display processor 412 has a function to display, on the display 43, contents of a Talkroom for interacting with the server 10 or the terminal 20.

### {Data}

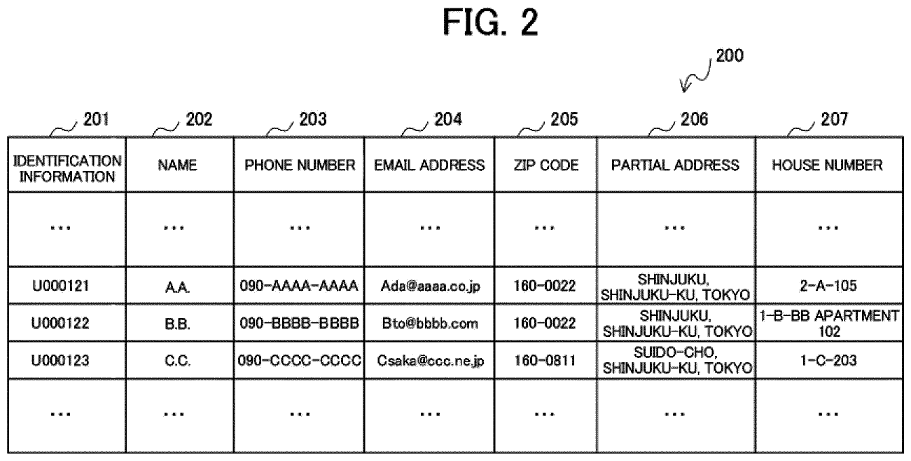

FIG. 2 is a conceptual data diagram illustrating an example of user information stored in the storage 15 of the server 10. As illustrated in FIG. 2, the user information 200 is information about each user using a service provided by the server 10. The user information 200 is, for example, without limitation, information in which identification information 201, name 202, phone number 203, email address 204, zip code 205, partial address 206, and house number 207 are correlated for each user. The user information 200 may or may not include each of the information items illustrated in FIG. 2. The information items indicated in the user information 200 are inputted by the user via his/her terminal 20, and are transmitted to the server 10 by the communication I/F 22 according to an instruction from the controller 21 of the terminal 20. The controller 11 stores the information in the storage 15 as the user information 200. The user information 200 includes information that relates to a user but does not render each individual user uniquely identifiable (an example, without limitation, of “first information”), and information that renders each individual user identifiable (an example, without limitation, of “second information”). In the example of FIG. 2, the identification information 201, the zip code 205, and the partial address 206 are information that relate to a user but do not render each individual user uniquely identifiable. In the example of FIG. 2, the name 202, the phone number 203, the email address 204, and the house number 207 are information that render each individual user identifiable.

In the communication system 1, the identification information 201 is an identifier with which the server 10 uniquely identifies each user. The identification information 201 may be in any format so long as each user can be identified, and it may be a combination employing some or all of alphabets, symbols, numbers, or the like.

The name 202 is the name of the user indicated by the corresponding identification information 201, and may be a name registered by the user when he/she uses a service provided by the server 10.

The phone number 203 is information indicating the phone number of an instrument with which voice calls are possible with the user indicated by the corresponding identification information 201. A plurality of phone numbers 203 may be stored for a single user.

The email address 204 is information indicating an address with which communication by email is possible with the user indicated by the corresponding identification information 201. A plurality of email addresses 204 may be stored for a single user.

The zip code 205 is information indicating a zip (postal) code assigned to a postal address of the user indicated by the corresponding identification information 201.

The partial address 206 is information indicating a location of residence of the user indicated by the corresponding identification information 201, and is information indicating an approximate location.

The house number 207 is information indicating the house number of the location of residence of the user indicated by the corresponding identification information 201. For example, the partial address 206 and the house number 207 are used in combination to indicate a user's address.

By storing the user information illustrated in FIG. 2, the server 10 can provide a company server 40 with detailed information of the user if there is permission from the user.

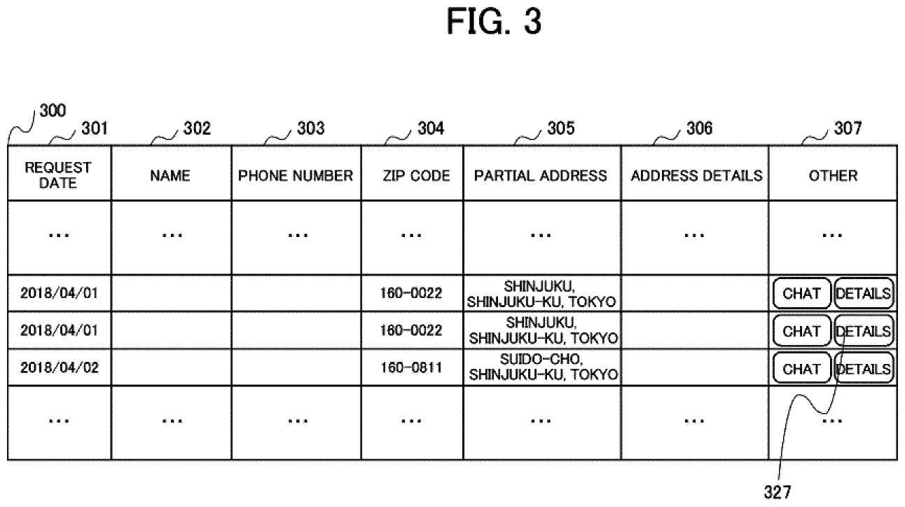

FIG. 3 is a conceptual data diagram illustrating an example of request information indicating requests provided from the server 10 to a company server 40. The request information 300 illustrated in FIG. 3 is information for requesting, from users, the provision of a service provided by the company server 40, and is information provided from the server 10. As illustrated in FIG. 3, the request information 300 is information in which the request date 301, name 302, phone number 303, zip code 304, partial address 305, address details 306, and other 307 are correlated. The request information 300 only needs to include information desired for providing the service, and does not have to include all the information illustrated in FIG. 3. In some example embodiments, the request information may include additional information other than those illustrated in FIG. 3 so long as it is information relating to users. The request information 300 is stored in the storage 45 of each company server 40.

The request date 301 is information indicating the date on which a user made a request.

The name 302 is information indicating the user's name.

The phone number 303 is information indicating the phone number of an instrument with which voice calls are possible with the corresponding user. A plurality of phone numbers 303 may be stored for a single user.

The zip code 304 is information indicating a zip (postal) code assigned to a postal address of the corresponding user.

The partial address 305 is information indicating a location of residence of the corresponding user, and is information indicating an approximate location. Based on this information on the approximate location, it is possible to make a rough estimate for e.g. a moving service, even though the user's exact residence cannot be identified.

The address details 306 are information indicating the house number of the location of residence of the corresponding user. For example, the partial address 305 and the address details 306 are used in combination to indicate an address.

Other 307 includes a chat button for enabling Talk (exchanging information) with the corresponding user, and a details button 327 for acquiring detailed information relating to the user if the corresponding user gives permission. Clicking the chat button will activate a Talkroom, which is a screen for the messaging service provided by the server 10, for interaction between the company server 40 and the corresponding user, thereby enabling chatting. Clicking the details button 327 will allow detailed information relating to the corresponding user to be obtained on condition that the user has given permission.

The request information 300 illustrated in FIG. 3 is information at an initial stage as provided from the server 10, and is information allowing only disclosure of information with which the users are unidentifiable. Thus, information that will render users identifiable is left blank at the initial stage. In response to an operator of the company server 40 clicking the details button 327 with permission from the user, detailed user information corresponding to that user can be acquired from the server 10.

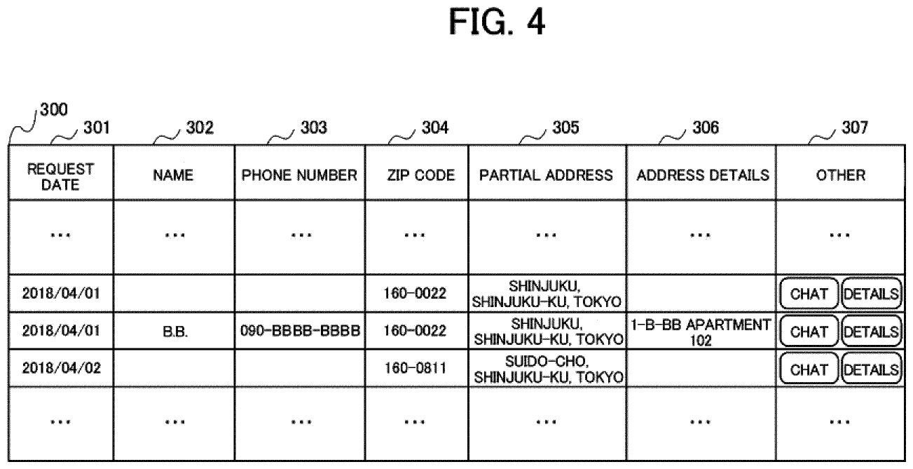

FIG. 4 illustrates the request information 300 after the details button 327 of FIG. 3 is clicked. The transition from FIG. 3 to FIG. 4 shows that the name “B.B.”, her phone number 303, and address details 306 are revealed to the company server 40.

### {Operation}

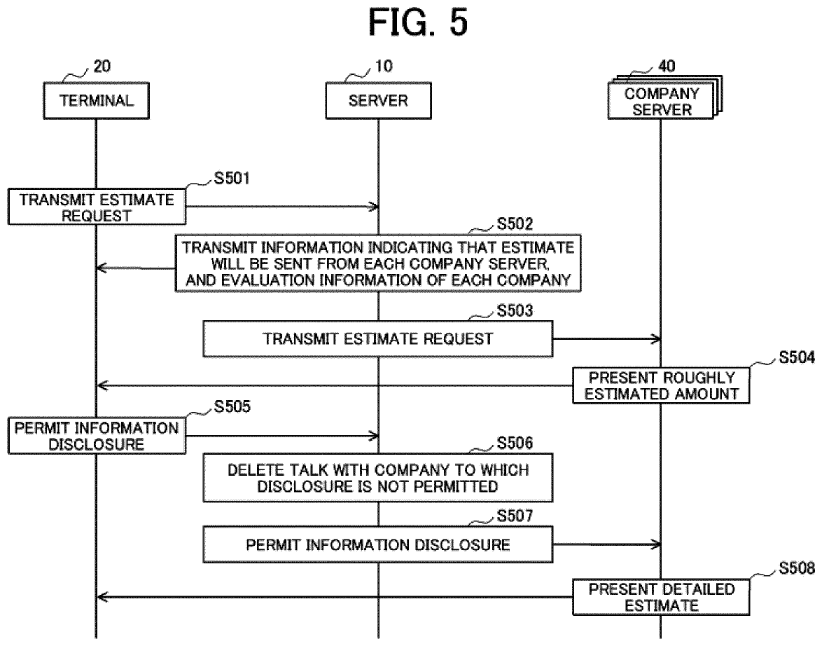

FIG. 5 is a sequence diagram illustrating operations of the communication system 1 according to an example embodiment. The sequence diagram of FIG. 5 illustrates a flow from when a user makes a service provision request to when company servers 40 transmit estimates to the user.

As illustrated in FIG. 5, for example, the user accesses, from his/her terminal 20, a web form provided by the server 10 to request a service provided by company servers 40, and transmits an estimate request to the server 10 (operation S501). In this example, the request is for a moving service. Thus, for example, the user enters information such as the moving destination and the number of people moving, and transmits the information from the terminal 20 to the server 10.

In response to receiving the estimate request, the server 10 transmits, to the terminal 20 that transmitted the estimate request, a response to the effect that company servers will send their estimates to the terminal 20. For example, without limitation, the server 10 transmits, to the terminal 20, information to the effect that estimates will be sent later from the respective company servers, and evaluation information indicating evaluations of the respective companies, via a dedicated Talkroom between the server 10 and the terminal 20 (operation S502). Further, the server 10 transmits the user's estimate request to a plurality of company servers (operation S503).

In response to receiving the estimate request, each company server 40 calculates a roughly estimated amount based on the conditions included in the estimate request. The company server 40 then transmits information indicating the estimated amount to the terminal 20 via the server 10 by, for example, writing the calculated estimated amount in a Talkroom created between the company server 40 and the terminal 20 (operation S504).

The user of the terminal 20 reviews the roughly estimated amount that has been presented, displayed on the terminal 20, and confirms the contents thereof. The user then enters permission to disclose information for requesting a detailed estimate to the company server that presented the estimate. The terminal 20 sends the information-disclosure permission to the server 10 (operation S505).

The server 10 deletes Talks with company servers for which the terminal 20 did not permit information disclosure (operation S506). On the other hand, the server 10 transmits the user's detailed personal information, in response to an information-disclosure request from company server(s) 40 for which the user permitted information disclosure (operation S507).

In response to viewing the user's detailed information, an operator of the company server 40 presents a detailed estimate to the terminal 20 (operation S508).

In this way, the user can disclose his/her detailed information only to company servers that the user feels he/she can trust, and get estimates from those companies.

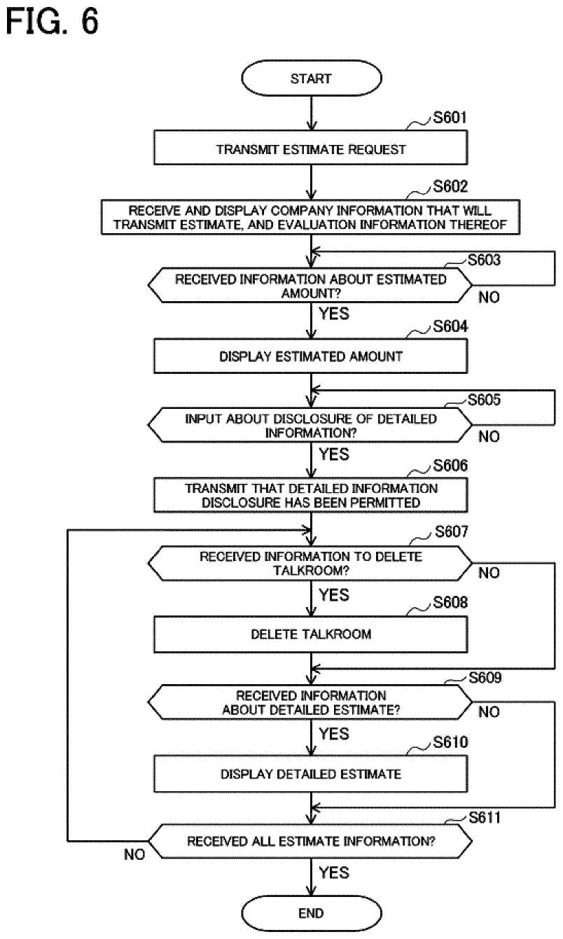

FIG. 6 is a flowchart illustrating processes at the terminal 20 for achieving the interaction illustrated in FIG. 5, up to when the terminal 20 obtains an estimate.

As illustrated in FIG. 6, the user transmits a request for receiving a service from a company server 40 (e.g., a request for an estimate for moving) from the terminal 20 to the server 10 (operation S601). For example, the terminal 20 accepts an input of an estimate request as accepted from the user via the input/output device 23. According to this input, the communication I/F 22 transmits the estimate request to the server 10 via the network 30.

From the server 10 which has received the estimate request, the communication I/F 22 receives information about companies that are scheduled to send estimates. The communication I/F 22 transmits the received company information to the controller 21. The display processor 212 of the controller 21 makes the display 24 display the transmitted company information (operation S602).

The controller 21 determines whether or not the communication I/F 22 received information about an estimated amount (operation S603). The controller 21 goes on standby until it receives estimated amount information (NO at operation S603). Note that the estimated amount received at this stage is a roughly estimated amount.

In response to receiving information about an estimated amount (YES at operation S603), the display processor 212 of the controller 21 displays the received estimated amount information in a Talkroom corresponding to the company server that transmitted the estimate (operation S604). Note that reception of information about companies that are scheduled to send estimates at operation S602 may or may not be simultaneous with reception of estimated amount information at operation S603.

The user views the roughly estimated amount, and if the user thinks that he/she wants a detailed estimate, the user enters permission to transmit his/her detailed information to the company server 40 to request a detailed estimate. The input/output device 23 of the terminal 20 determines whether or not the user entered permission to disclose detailed information (operation S605).

If the user has inputted permission to disclose detailed information (YES at operation S605), the controller 21 transmits, to the server 10 via the communication I/F 22, information indicating permission to disclose detailed information (operation S606). This information includes information indicating the company server(s) 40 to which disclosure is permitted. For example, without limitation, the company server(s) 40 can be identified by using information that renders identifiable the Talkroom in which the user was performing Talk (or exchanging information).

The controller 21 determines whether or not the communication I/F 22 has received Talkroom deletion information (operation S607). Herein, Talkroom deletion information is transmitted from the server 10, and is information for instructing deletion of Talkrooms with company servers 40 for which the user did not permit disclosure of detailed information. If no Talkroom deletion information has been received (NO at operation S607), the process proceeds to operation S609. If Talkroom deletion information has been received (YES at operation S607), the message processor 211 deletes Talkroom(s) of company server(s) 40 indicated by the Talkroom deletion information from among the group of Talkrooms in the messaging service being used by the user (operation S608).

On the other hand, the controller 21 determines whether or not the communication I/F 22 has received information about a detailed estimate (operation S609). If detailed estimate information has been received (YES at operation S609), the communication I/F 22 transmits the received estimate information to the controller 21. The display processor 212 of the controller 21 displays the received detailed estimate information on the Talkroom (operation S610).

The controller 21 determines whether or not detailed estimate information has been received from all of the company servers 40 to which permission to disclose detailed information was given in operation S605 (operation S611). If detailed estimate information has not yet been received from all of the relevant company servers 40 (NO at operation S611), the process returns to operation S607, and if the information has been received (YES at operation S611), the process is ended.

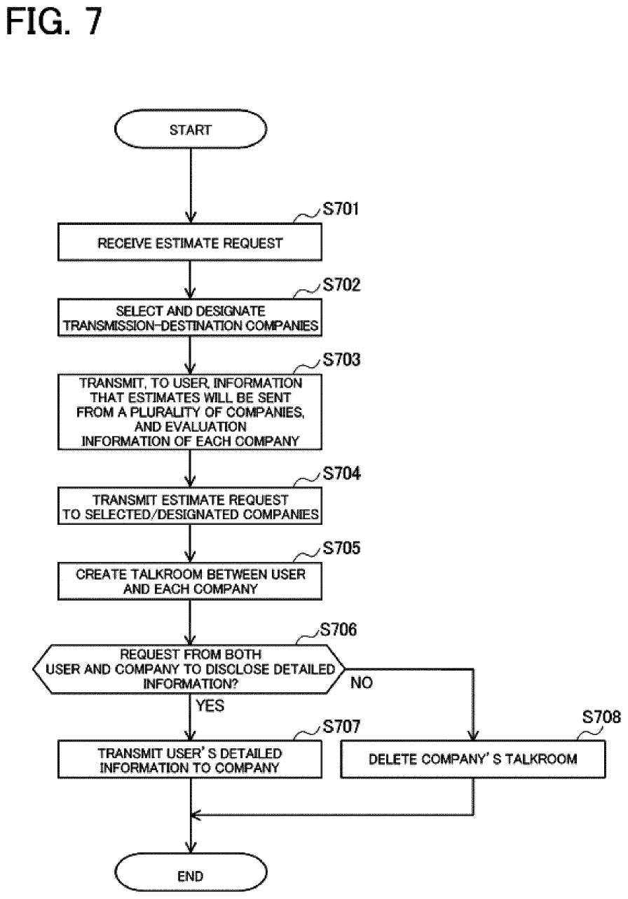

Next, processes of the server 10 for achieving the interaction illustrated in FIG. 5 are described using FIG. 7. FIG. 7 is a flowchart illustrating the processes of the server 10 when a user has made an estimate request.

As illustrated in FIG. 7, the communication I/F 14 of the server 10 receives an estimate request from the terminal 20 via the network 30 (operation S701). The communication I/F 14 transmits the received estimate request to the controller 11. In response to receiving the estimate request, the controller 11 designates a desired (or alternatively, predetermined) number of company servers 40 according to a desired (or alternatively, predetermined) criterion as destinations for transmitting the estimate request (operation S702).

The controller 11 creates a Talkroom between the server 10 and the user's terminal 20, and transmits, on the created Talkroom, information to the effect that estimates will be sent to the user from a plurality of designated companies, and also evaluation information of those companies (operation S703).

To inform each of the designated company servers 40 about the estimate request from the user, the controller 11 instructs the communication I/F 14 to transmit, to the company servers 40 via the network 30, information indicating the estimate request from the user. According to this instruction, the communication I/F 14 transmits the user's estimate request to each of the designated company servers 40 (operation S704). At this time, the server 10 may transmit an estimate request from only one user, or may transmit estimate requests from a plurality of users.

The controller 11 then creates a Talkroom between the user and each of the designated company servers 40 (operation S705). In response to receiving the estimate request from the server 10, each of the company servers 40 can start interacting with the user via the respective Talkroom.

The controller 11 determines whether or not there has been a request to disclose detailed information about the user of the terminal 20 from both the user's terminal 20 and the company server 40 (operation S706). This can be determined based on whether or not there has been communication indicating a request to disclose detailed information from both the user's terminal 20 and each company server 40.

If there has been a request to disclose detailed information about the user from both the user's terminal 20 and the company server 40 (YES at operation S706), the controller 11 of the server 10 transmits the user's detailed information to the company server 40 by using user information stored in the storage 15 (operation S707). Note that, although this is an example in which both the user's terminal 20 and the company server 40 request the disclosure of the user's detailed information (operation S706), in other examples, the disclosure request may be only from the user's terminal 20, or may not be only from the user's terminal 20. In some example embodiments, the disclosure request may be only from the company server 40, but in this case, it may be prudent to use a disclosure request for user's detailed information accompanied by evidence of permission from the user.

On the other hand, if there is no request to disclose the user's detailed information from both of the user's terminal 20 and the company server 40 (NO at operation S706), the controller 11 of the server 10 deletes the Talkroom between the corresponding company server 40 and the user (operation S708). Herein, “if there is no request to disclose the user's detailed information from both of the user's terminal 20 and the company server 40” includes both cases where there was no notification of a disclosure request from the user's terminal 20, and cases where there was a notification from the user's terminal 20 not to disclose the information to specific company server(s) 40. Further, it is possible to determine that “there was no notification of a disclosure request from the user's terminal 20” based on the fact that the user has requested information to be disclosed to another company and a desired (or alternatively, predetermined) time has elapsed from the creation of a Talkroom between the user and the other company server 40.

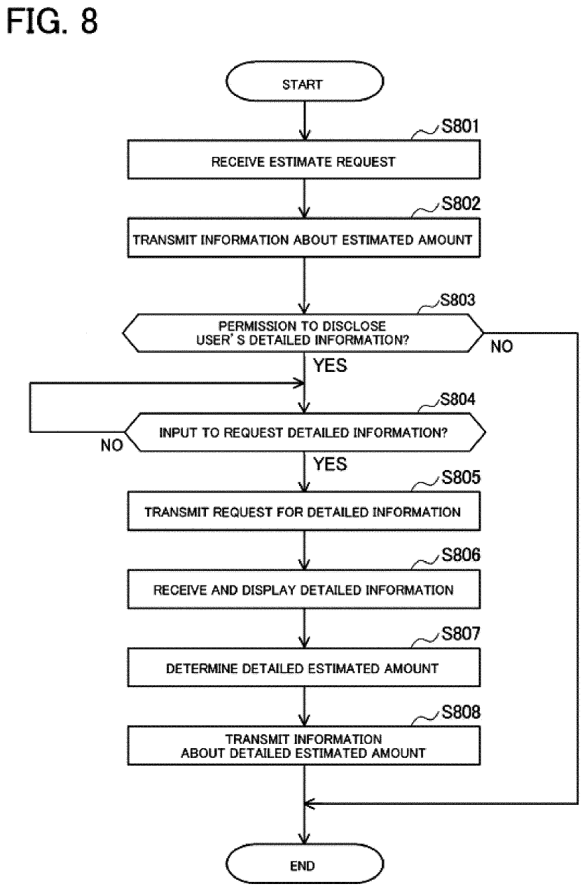

FIG. 8 is a flowchart illustrating processes at a company server 40 for achieving the interaction illustrated in FIG. 5.

As illustrated in FIG. 8, the communication I/F 44 of the company server 40 receives the user's estimate request from the server 10 (operation S801). The estimate request includes information for making a rough estimate, such as an approximate location from which the user is moving (moving origin), moving destination, and the number of people moving. The communication I/F 44 transmits the received estimate request to the controller 41. The display processor 412 of the controller 41 displays the estimate request on the display 43. In response to viewing this information, an operator of the company server 40 determines a roughly estimated amount. Herein, “roughly estimated amount” refers to an amount (price) in a range that can be estimated based on the information provided to the company server 40, and is, for example, without limitation, an estimated amount calculated from the information within a range provided to the company server by extracting a similar service the company handled in the past and using the estimated amount or billing amount for that case. Note here that a plurality of cases handled in the past can be extracted, and in this case, a roughly estimated amount can be found by using either (i) the estimated or billing amount of a case having the highest similarity, or (ii) an average value of estimated amounts or billing amounts of a plurality of cases, or (iii) an average value of estimated amounts or billing amounts of a desired (or alternatively, predetermined) number of cases or a desired (or alternatively, predetermined) percentage of cases with high similarities among the plurality of cases.

The controller 41 instructs the communication I/F 44 to transmit the roughly estimated amount which has been determined to the user terminal 20 for which the estimated amount has been determined. The communication I/F 44 transmits the information about the estimated amount to the designated user terminal 20 (operation S802). If the company server 40 has obtained the user's permission to disclose detailed information in a Talk with the user (YES at operation S803), the controller 41 makes the communication I/F 41 transmit a request to disclose the corresponding user's detailed information according to an input to the input/output device 42 by the operator of the company server 40 (YES at operation S804). The communication I/F 41 transmits the request to disclose detailed information to the server 10 (operation S805).

In response to the request to disclose detailed information, the communication I/F 44 receives the corresponding user's detailed information transmitted from the server 10. The communication I/F 44 transmits the received detailed information to the controller 41. The display processor 412 of the controller 41 makes the display 43 display the received detailed information (operation S806).

In response to viewing the displayed detailed information, the operator of the company server 40 determines a detailed estimated amount (operation S807). Note that this determination may be made by the company server 40. For example, a program for calculating moving fees based on the moving origin, moving destination, and number of people moving may be stored in advance, and an estimated amount may be calculated by executing this program.

The controller 41 makes the communication I/F 44 transmit information about the detailed estimated amount that has been determined. The communication I/F 44 transmits the information about the detailed estimated amount to the user terminal 20 via the network 30 (operation S808), and the process is ended. In operation S803, if permission to disclose the detailed information could not be obtained from the user (NO at operation S803), the process is ended.

Although not illustrated in the flowchart of FIG. 8, it goes without saying that, in order to actually draw up an estimate after the detailed information is disclosed, the operator of the company server 40 may visit the user in person to create an estimate.

The above describes the processes at the company server 40 up to when it issues a detailed estimate.

### Concrete Examples

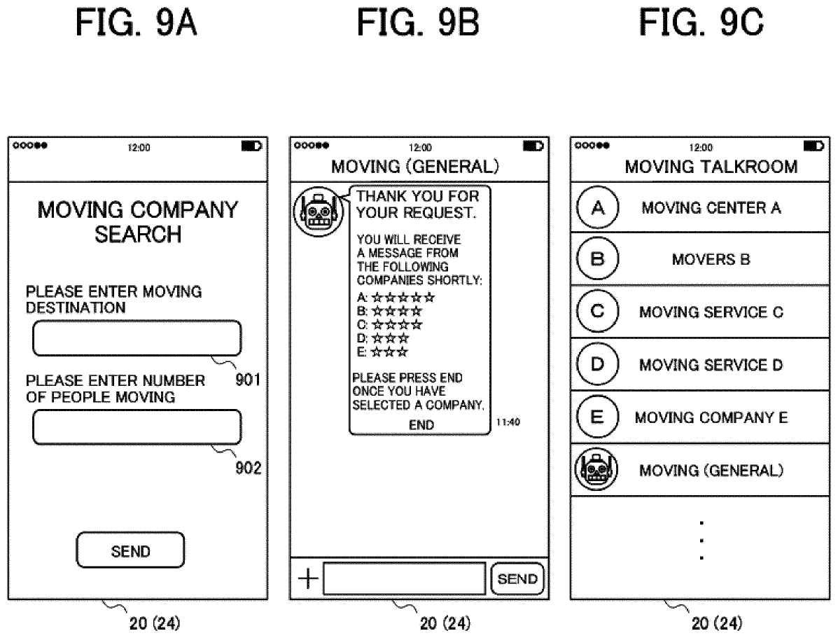

The description above will be explained more comprehensibly by way of examples. FIG. 9A is a diagram illustrating an example of a user interface (UI) for inputting, the UI being displayed on the display 24 when the user requests an estimate by using the user's terminal 20. FIG. 9A illustrates an example of a display screen including an input box 901 for inputting information relating to the moving destination, and an input box 902 for inputting the number of people moving, as desired items (e.g., information items) for moving. Note that it is not necessary to enter details of the address in the input box 901, and only information about the area/region may be required. In response to clicking of the Send button after entering the required items in FIG. 9A, the terminal 20 transmits an estimate request to the server 10 (see operation S501 in FIG. 5).

In response to receiving this estimate request, the server 10 issues a notification to the effect that company servers 40 designated by the server 10 will send their estimates, as illustrated in FIG. 9B, for example (see operation S502 in FIG. 5). FIG. 9B illustrates an example wherein five companies, from A to E, will provide estimates. Further, as illustrated in FIG. 9B, information about evaluations (ratings) of the respective companies is also indicated. In the example of FIG. 9B, the evaluation is indicated by a star rating, wherein the more stars, the higher the evaluation (rating). Note, however, that the method for displaying the evaluation information is not limited to the example of FIG. 9B, and various formats are conceivable, such as numerical values, evaluation using letter coloring, or evaluation (reviews) by text. The server 10 may store such evaluation information in advance, or may employ evaluation information acquired from the network. In cases where the displaying based on the evaluation information is rendered as numerical values, the evaluation may be displayed in ascending or descending order of the numerical values indicating the evaluation. Further, in cases where an evaluation is lower than a desired (or alternatively, predetermined) threshold, the system may be configured such that the corresponding company will not be displayed. The system may be configured such that companies with poor evaluations are screened in advance at the server 10 so that poorly evaluated company servers 40 will not be provided with estimate requests. The user may make settings such that companies with lower ratings than a reference (or alternatively, predetermined) company will not be displayed on the screen. In cases where such a setting is made, the controller 11 may compare the rating of a reference (or alternatively, predetermined) company and the rating of the company for which determination is made regarding whether it should be displayed, and may determine not to display that company if its rating is lower than that of the reference company.

As illustrated in FIG. 9C, Talkrooms are created between the user and the respective company servers 40 selected by the server 10. FIG. 9C is an example of a screen displayed on the user terminal 20, and is a diagram illustrating a list of Talkrooms. This list of Talkrooms may be referred to as a “Talk List”. In FIG. 9C, in response to a selection (touching) of one of the Talkrooms, the displaying changes to the dedicated Talkroom that has been selected. As illustrated in FIG. 9C, it can be understood that there is a Talkroom for each company server 40 that will provide an estimate.

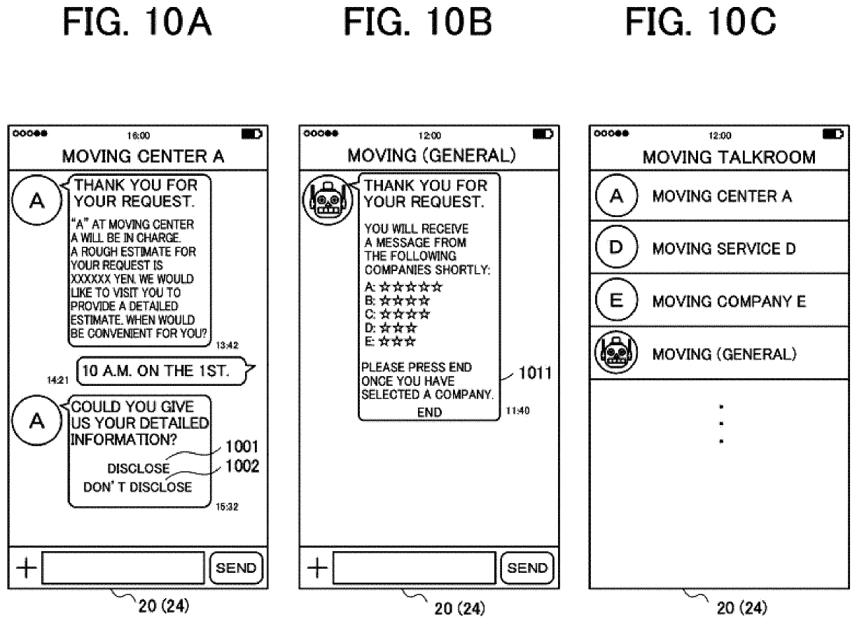

For example, in response to selection of Moving Center A illustrated in FIG. 9C, the display 24 of the terminal 20 will display a Talk screen between the user and Moving Center A (Company A), as illustrated in FIG. 10A. As can be understood from FIG. 10A, Company A has presented “XXXXXX yen” as a roughly estimated amount for its moving service.

In cases where the user is to permit disclosure of detailed information, the user can touch section 1001 indicated as “Disclose” in FIG. 10A, and thereby the terminal 20 can notify the server 10 that permission has been made to disclose, to Company A, detailed information of the user of the terminal 20. On the other hand, if the user is not going to give permission, the user can touch section 1002 indicated as “Don't disclose” in FIG. 10A, which prevents disclosure of detailed information to Company A, resulting in no further negotiation therewith. In cases of non-disclosure, the terminal 20 may transmit information, to the server 10, indicating termination of further negotiation. Note that, other than as explained above using FIG. 10A, the selection of companies to which detailed information is to be disclosed may be done, for example, without limitation, by selecting (touching) the companies to which detailed information is to be disclosed from the Talk List of companies as illustrated in FIG. 9C. The system may be configured such that Talks with companies that have not been selected (touched) here are deleted.

After completion of inputting execution/non-execution of disclosure of detailed information for each of the company servers 40 (although this does not have to be completed), the user touches the End button 1011, which indicates that the user has decided on a company, in the Talk with the server 10. Touching of the End button 1011 may be executed at the stage where the user has decided on companies to request detailed estimates, or at the stage where the user has decided on a company to actually request moving service. In cases where it is at the stage where the user has decided on companies to request detailed estimates, the Talkrooms of companies which have not been determined as destinations for disclosing detailed information at this point are deleted. For example, the Talkrooms are deleted as illustrated in FIG. 10C. FIG. 10C shows an example wherein the user has selected Companies A, D, and E, whereas the Talkrooms for Companies B and C have been deleted.

From the transition from FIG. 9C to FIG. 10C, it can be understood that the Talkrooms for Companies B and C have been deleted. Then, the user will exchange estimates with Companies A, D and E, to actually request provision of service.

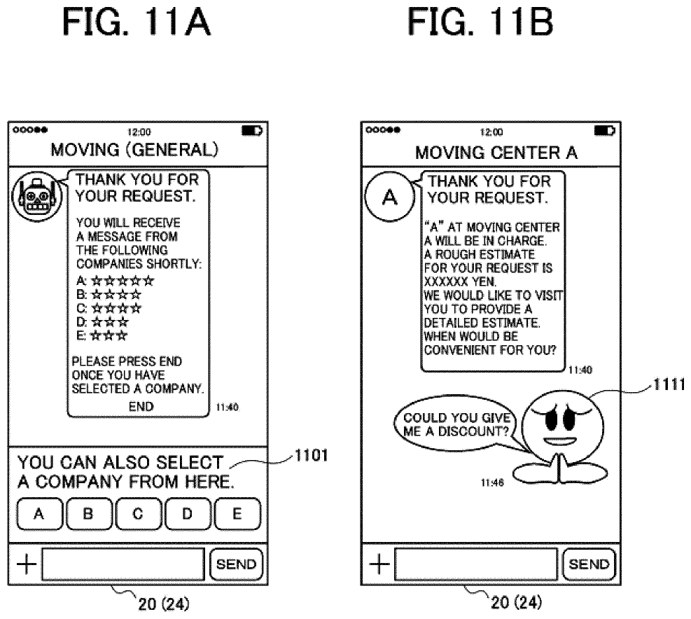

Note that the selection of companies for requesting detailed estimates (e.g., selection of whom to disclose the user's personal information) is not limited to the example illustrated in FIG. 10A. For example, as illustrated in FIG. 11A, the configuration may allow selection according to a format referred to as a “rich menu” 1101 in the Talk between the server 10 and the user. A “rich menu” is an account-specific menu, wherein the contents thereof can be set (or customized) by the user, the server 10 (or an operator thereof), or the company server 40 (or an operator thereof) participating in the Talk. In this example, a rich menu is a dedicated menu for selecting companies for requesting estimates. For example, the contents of a rich menu are set by the server 10 or the company server 40, so that the service-providing entity can offer convenience to the user.

The messaging service may prepare, in advance, image information 1111 for interacting with companies, and may be configured so that the user can use this image information. This image may be referred to as a “stamp”, and may be stored in the server 10 or another server communicable with the server 10, and the user may download and use the image. For example, without limitation, the image may be an image for price negotiation as illustrated in FIG. 11B, or an image requesting date adjustment. In some examples, it may be image information indicating a price acceptable by the user, or image information indicating that the user is willing to request the company's service at a certain price. In these cases, the price on the image information may be changeable. Stated differently, the price to be displayed as an image may be designated (inputted) by the user via the terminal 20. By preparing and providing such images in advance, even if a user is uncomfortable with negotiations, the user can negotiate smoothly and without hesitation. Note that, although this example uses image information to execute interaction (e.g., transaction), it goes without saying that the user can directly transmit messages (textual information; text) for transaction in a Talkroom.

Further, although the foregoing example embodiment describes an example for requesting an estimate for a moving service, the estimate request is not limited to moving. It goes without saying that any service may be applicable, so long as it is a service for which an estimate may be requested and for which there are a plurality of competitors. Any service is applicable, so long as it is a service for which a rough estimate can be provided by using simple information, and then a detailed estimate can be provided by using detailed information. The system described in the first example embodiment may be used, for example, without limitation, for insurance estimates, real estate dealing estimates, estimates from professionals (lawyers, accountants, etc.), estimates from hospitals, estimates for constructing intra-company systems, crowdsourcing estimates, and estimates from EC sites being used. Some examples will be described below.

For insurance estimates, the user presents information that does not render the user identifiable, such as the desired type of insurance and the user's age. The user receives evaluation information of insurance companies. For example, without limitation, the evaluation information of each insurance company may include information indicating evaluation based on e.g. the insurance company's performance, user ratings, and cost performance. Each insurance company may or may not present its estimate fee and/or plan regarding the insurance at that stage. Thereafter, the user can disclose detailed information to a trustworthy insurance company, to obtain a detailed estimate.

For real estate dealing estimates, for example, the user presents conditions regarding desired properties. The user receives evaluation information of real estate companies. For example, without limitation, the evaluation information of each real estate company may include information indicating evaluation based on e.g. the company's real estate sales performance, region of specialty, and cost performance. The real estate company may or may not present, at that stage, conditions matching the user's desire and a simple estimate of the sale/purchase price or rent for those conditions. Thereafter, the user can disclose detailed information to a trustworthy real estate company, to obtain a detailed estimate.

For estimates from professionals (lawyers, accountants, etc.), for example, when considering to consult a lawyer as a type of professional, the user discloses only information that does not render the user identifiable, such as the type of work the user is seeking and current circumstances. In response, the user receives evaluation information of lawyers. For example, without limitation, the evaluation information of each lawyer may include information based on, for example, areas of expertise, customer ratings, and consultation fee. Each lawyer may or may not present an estimate of his/her fee at the stage where only simple information has been received from the user. Thereafter, the user may disclose detailed information to a trustworthy lawyer.

For estimates from hospitals, for example, the user requests a rough estimate of medical service fees by disclosing only information such as the disease name and patient's state. In response, the user receives evaluation information of hospitals or doctors. For example, without limitation, the evaluation information of each hospital or doctor may include information indicating evaluation based on e.g. medical areas of expertise, treatment performance, patients' impressions, and medical service fee. After receiving the evaluation information, the user may disclose detailed information to a trustworthy hospital or doctor, to receive a detailed estimate.

For estimates from electronic commerce (EC) sites, for example, it is conceivable that a user may request for estimates from a plurality of sites providing similar services. An electronic commerce (EC) site refers to a site where a company sells products and/or services of that company (may include products/services from other companies) on an independently operated website on the Internet. For example, without limitation, EC sites may provide goods-sales services, video-on-demand services, e-books sales services, or travel agency services. For example, without limitation, on an EC site providing travel services, the user discloses information that does not render the user identifiable, such as the desired travel destination and date. The user receives evaluation information of EC sites. For example, without limitation, the evaluation information of each EC site providing travel services may include information indicating evaluation based on e.g. travel destinations in which the company specializes, number of people the company is good at serving, and cost performance. In response to the user's information, each EC site presents its rough estimate and plan. The user may then provide detailed information to EC sites that captured the user's interest. Note that the EC site may be operated by a company or by an individual person.

As described above, the system according to this example embodiment is useful for various types of businesses. Note that, although the first example embodiment provides estimates in two stages, the configuration is not limited thereto, and the system may be configured such that a user determines a dealer (company server 40) to which detailed information is to be disclosed based only on the evaluation information.

### Modified Examples of First Example Embodiment

(1) In the foregoing first example embodiment, the server 10 transmits the user's detailed information stored by the server 10 to a company server in cases where both the user and the company server request for disclosure of the detailed information. However, the method for transmitting the user's detailed information to the company server 40 is not limited thereto. It goes without saying that the user can transmit his/her detailed information directly to the company server 40. Also, which information to display on the terminal 20 may be chosen by the terminal 20 or may be designated by the server 10.

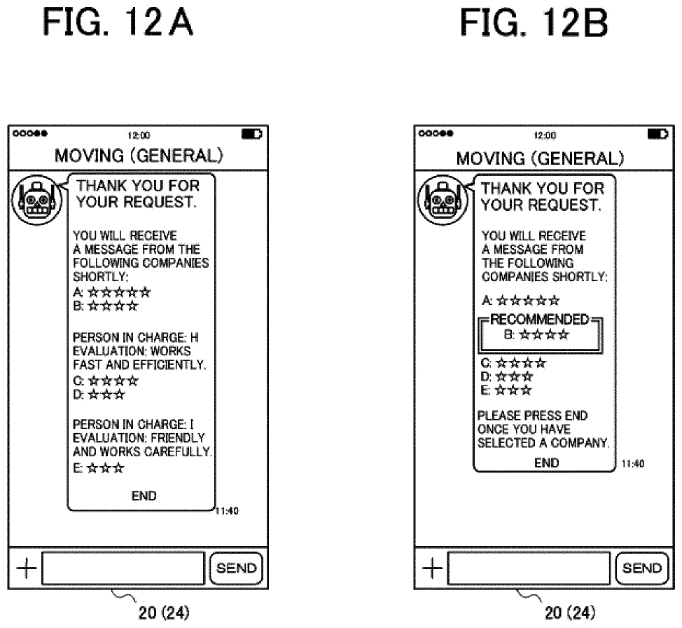

(2) In the foregoing first example embodiment, the evaluation information is described as indicating the evaluation of each company server 40 as a whole. The evaluation information, however, is not limited to the evaluation of the company itself, and may indicate the evaluation of a person in charge, who is actually going to take on the service provided by the company server 40. For example, without limitation, as illustrated in FIG. 12A, in cases where there is evaluation information of a person in charge for a certain company, the evaluation information of the person in charge may be presented. FIG. 12A is an example of a screen displayed on the display 24 of the user terminal 20, and is a diagram of a screen showing a Talkroom between the server 10 and the user. As illustrated in FIG. 12A, the name of the person in charge and his/her evaluation are indicated in association with the company name. In this example, the evaluation of the person in charge is written in text, describing the characteristics of the person in charge. The evaluation of the person in charge, however, is not limited to such written evaluation, and may instead be expressed as information indicating the evaluation (rating) of the person in charge in numerical form, e.g., by using symbols or numbers. In some example embodiments, a face photo of the person in charge may be displayed together with the name. In the example of FIG. 12A, “H” will be the person in charge in cases where Company B undertakes the service to the user. In this example, “H” is evaluated as “Works fast and efficiently.” In cases where there is an evaluation of the person in charge, an evaluation of the company may be provided. The server 10 may store the evaluation information of persons in charge, indicating the evaluation of each person in charge belonging to the respective company servers 40, in the storage 15 in advance. In cases where the evaluation information is not stored, it may be acquired from each company server 40 by communication. It goes without saying that the evaluation of the person in charge and the evaluation of the company itself may be presented side by side.

(3) In the foregoing first example embodiment, only the evaluation information of each of the company servers 40 is displayed, but it is possible to specifically indicate a recommended company to the user from among the company servers 40 and display the recommendation on the display 24 of the terminal 20. An example of displaying a recommendation will be described below.

In response to receiving an estimate request from the user, the controller 11 of the server 10 identifies a company matching the user's preference (or indication) by using the user information 200. The server 10 notifies that the identified company is recommended at the time of transmitting the evaluation information. This notification may take any format so long as the recommended company can be recognized in comparison to the other companies. For example, an image or text indicating the recommendation may be displayed together with the company name (e.g., without limitation, a bubble including a recommendation image or text may be displayed together with the company name), or the recommended company may be displayed in a color different from companies that are not recommended. The terminal 20 may determine the display format, or it may be designated by the server 10. FIG. 12B illustrates an example wherein a recommended company is displayed on the display 24 of the user terminal 20. FIG. 12B is a diagram illustrating an example of a Talkroom between the user and the server 10 displayed on the display 24 of the user terminal 20, the diagram illustrating a screen showing information transmitted from the server 10 in response to the user's estimate request, and showing a message to the effect that notifications about estimated amounts will be transmitted from the company servers 40. In the example of FIG. 12B, the name of Company B is displayed according to a different format from the other companies, to indicate that Company B is recommended. At this time, text such as “Recommended” may be displayed in association with the company name so that it is more recognizable to the user, as illustrated in FIG. 12B. In this way, by introducing a plurality of companies to the user and also displaying the name of a company, from among the plurality of companies, that is recommended to the user from the perspective of the server 10 in a manner discernible to the user, it is possible to make the user understand at a glance which company is recommended to the user from among the list of companies.

A method for determining a recommended company by the server 10 can be achieved by further including information about the user's preference (or indication) in the user information 200 and making the server 10 store information indicating characteristics of the company servers 40 in the storage 15. For example, without limitation, in cases where information indicating that the user prefers fast work speed is associated as the user's preference, a company committed to fast service is recommended. As another example, in cases where information indicating that the user values the atmosphere during work is associated as the user's preference, a company associated with information indicating that it provides work in a friendly atmosphere is selected as the recommendation. Stated differently, the controller 11 of the server 10 determines whether or not to recommend a company based on a matching degree between the user's preference information and information about, for example, the job-performance characteristics and/or motto of the company corresponding to each company server 40. In this way, the server 10 and the terminal 20 can provide information beneficial to the user in determining which company server 40 to place a request with.

(4) The foregoing first example embodiment describes processes up to when a detailed estimate is received. Actually, the user will then determine a company server 40 to which a request for service is to be placed, and will receive the service from that company server 40. At that time (e.g., after receiving the service from the company server 40), the user may transmit the user's evaluation information, indicating an evaluation of the company server 40 based on the user's own impressions, to the server 10 by using his/her terminal 20. The server 10 then stores the user's evaluation information in the storage 15. The controller 11 of the server 10 may reflect the users' evaluation information from various users who received services from the respective companies onto the respective companies' evaluation information. Every time the controller 11 receives user's evaluation information, the controller 11 may reflect the user's evaluation information on the evaluation information of the corresponding company. In some example embodiments, the user's evaluation information may be reflected onto the evaluation information of each company once every desired (or alternatively, predetermined) period (e.g., once per month). In this way, each company can be evaluated by using firsthand information about the company provided at a time closer to the present.

Although this example focuses on an evaluation of each company, instead, an evaluation of the person who actually did the work may transmitted, or both pieces of information may be transmitted.

### Effects of Example Embodiment

Some effects of the first example embodiment are described below.

The terminal 20 according to the foregoing first example embodiment transmits information that does not render the user identifiable (estimate request; an example, without limitation, of “first information”) as user information from the user to the server 10, and receives evaluation information from the server 10 as an example of information relating to company servers, which are candidates for receiving requests based on estimates, and displays the evaluation information.

In this way, when determining which companies to send estimate requests to, the user of the terminal 20 can visually confirm company information, such as the company's reputation, without having to collect various information on his/her own. Thus, it is possible to reduce the user's burden when comparing and considering companies at the time of requesting a service.

Further, in response to the request from the terminal 20, the server 10 transmits, to the terminal 20, evaluation information about companies that will provide estimates.

In this way, the server 10 can convey information relating to the evaluation of companies, such as service ratings, to the user of the terminal 20, and can thereby provide the user with information that may become an assistance at the time of deciding to which company to request service, thus improving convenience for the user.

Further, by permitting disclosure of the user's detailed information in a Talkroom with each company server, or by transmitting the detailed information on the user's own, the user's detailed information may be transmitted to each company server from the server 10 or the terminal 20.

In this way, further information about the user can be sent to the company server, so that the company server can make a detailed estimate.

Further, in response to receiving a request to disclose the user's detailed information from the company server 40, the server 10 may transmit further information about the user.

In this way, the server 10 can present information desired by the company server 40 to make a detailed estimate, thereby improving convenience for the company server 40 to make an estimate.

Further, the terminal 20 can change the format for displaying each of the companies (e.g., change the letter color or font size) based on company evaluation information transmitted from the server 10. As an example of information indicating the evaluation level (rating) of each company, the terminal may, for example, make the color for displaying a company having a high evaluation (rating) different from the color for displaying a company having a poor evaluation.

Further, the server 10 may be configured to transmit, to the terminal 20, display information indicating the evaluation of each company.

In this way, the terminal 20 can show the evaluation of each company by changing the display format thereof, and can thereby make the user recognize the evaluation (rating) of each company.

Further, the terminal 20 may display information indicating each company in accordance with a display order determined based on the evaluation information about the companies as transmitted from the server 10. Further, display information indicating information about each of the company servers 40 in an order based on the evaluation information may be transmitted at the time of transmitting the evaluation information from the server 10 to the terminal 20.

In this way, the user can recognize the evaluation level (rating) of each company according to the order in which the service-providing companies are displayed.

Further, the terminal 20 may not display a company having a poor evaluation by comparing the company with a desired (or alternatively, predetermined) company based on the evaluation information transmitted from the server 10.

Further, the server 10 may transmit the evaluation information so as to include information indicating whether or not to display a company as a prospective company that will provide an estimate, based on the evaluation indicated by the evaluation information.

In this way, the terminal 20 may not display a company having a poor evaluation (rating), and thus, the user can be prevented from making a request to that company. Thus, it is possible to reduce the possibility of user dissatisfaction that may arise if a user receives service by actually requesting service from a low-rated company.

For example, without limitation, “evaluation information” indicating the evaluation of each company may be information indicating the degree (level) of evaluation (or information indicating the actual evaluation (rating)).

In this way, the user can recognize the evaluation of each company directly and easily, and can obtain an easy-to-understand index in determining which company to make a service request to.

Further, the user of the terminal 20 may transmit, to the server 10, detailed information to be transmitted to a company server 40 for which the user decided to disclose his/her detailed information. Further, the server 10 may be configured to directly receive the user's detailed information from the terminal 20.

In this way, the user can determine the detailed information to be disclosed to each service-providing company server 40, each time the detailed information is transmitted. Further, in cases where the server 10 does not possess the user's detailed information, the server 10 can obtain the information from the user terminal 20 and transmit the information to a company server 40, so that an estimate request can be made to the company server 40.

Further, as information about a person in charge who will actually provide the service at the company, the terminal 20 may receive information indicating an evaluation of the person in charge. The information indicating the evaluation of the person in charge may be transmitted from the server 10 to the terminal 20.

In this way, the user can make the request after confirming what kind of person with whom the user will actually interact. This will increase the possibility that the user can receive a highly satisfying service.

Further, the terminal 20 may display a company server 40 recommended by the server 10 by distinguishing it from other company servers 40. As the recommended company server 40, the server 10 may select a company matching the preference of the user of the terminal 20.

In this way, the terminal 20 and the server 10 can provide the user with information as to which company, or company server 40, will provide a service more suitable for the user, and can thus provide assistance, or a material for determination, to the user for selecting which company to make a service request to.

Further, the terminal 20 may transmit, to the server 10, information for allowing the user to negotiate (transact) with the company server 40. The server 10 may receive the information for negotiation (transaction), and transmit it to the company server 40. The information indicating transaction may be a message (text information) or an image showing contents of the transaction.

In this way, the user can negotiate with the company server 40 via the server 10 by using the terminal 20, to make a transaction for receiving service. Thus, the user can request the provision of service from the company server 40 under conditions more preferable to the user.

Further, after receiving service from the company server 40, the user may transmit the user's evaluation information indicating an evaluation of the company, i.e., the user's impressions, from the terminal 20 to the server 10. This evaluation may be information indicating the evaluation of the person in charge at the company server 40 who actually provided the service, or may include both evaluations of the company and the person in charge.

In this way, the terminal 20 can transmit, to the server 10, the user's own evaluation of the company or the person in charge after receiving the service. In response to receiving the evaluation, the server 10 can reflect the user's evaluation onto the evaluation information when presenting the evaluation information to other users in the future, and can thereby provide information relating to evaluations even closer to real-time.

Further, the terminal 20 may display a list indicating various companies (e.g., a list of company names or a list of corresponding Talkrooms). The terminal 20 may accept selection from the user regarding whether or not to disclose the user's detailed information to each of the companies making estimates. The terminal 20 may terminate communication with a company server 40 to which the user has determined not to disclose detailed information.

In this way, communication with a company that has become undesirable to the user can be terminated, and therefore, the user does not have to communicate with that company in the future. Thus, for example, the user will not be subjected to sales activities from a company with which the user is not performing transaction.

Further, the terminal 20 can perform negotiations individually via respective Talkrooms created by the server 10 between the user and the respective companies.

In this way, the user can perform negotiations with each company without letting the company know about interactions with other companies and the situation thereof, and can thus perform transaction to his/her advantage.

Further, the terminal 20 may display information about each company server 40, with which to perform transaction, via a rich menu in a Talkroom between the terminal and the server 10.

In this way, information can be provided according to different formats/modes for respective users each enjoying service provided by the server 10.

### Second Example Embodiment

The foregoing first example embodiment described an example wherein a rough estimate can be provided without disclosing the user's detailed information, and then a detailed estimate can be provided by disclosing detailed information to a trustworthy dealer/company. With this configuration, undesirable dissemination of user information can be prevented, thereby suppressing unwanted contact, such as sales calls, from dealers. In employing a system that provides an estimate as described in the first example embodiment, there may be cases where the actual billing amount deviates from the estimate. In such cases, however, there is no way for the server 10 to recognize this deviation. Also, the upper management of a company may not be able to recognize this deviation.

For example, without limitation, it is conceivable that such a deviation from the estimate may occur in cases where a dealer/company (or person in charge) underestimates the price at the stage of providing an estimate in hope of getting the work, and then bills the actual amount at the time of billing, or in cases where the biller is unreasonably overbilling the user at the time of billing. Such a deviation between an estimate and an actual billing amount may dissatisfy the user, which may, in turn, lead to degradation of the company's reputation. A second example embodiment describes a system capable of suppressing deviation between an estimate and an actual billing amount.

It should be noted that the processes in the second example embodiment are processes from around the time when the service-providing entity issues a bill, after the user has received an estimate and actually requested a service. Therefore, the configuration is substantially the same as that illustrated in FIG. 1 of the first example embodiment. So, functions and processes that are the same as those in the first example embodiment are omitted from explanation in the present second example embodiment.

### {Configuration}

In addition to the functions described in the first example embodiment, the server 10 has a function to encourage the user to provide billing amount information, and a function to transmit some kind of reward in response to receiving billing amount information from the user.

When an agreement is established between the user and a company, the controller 11 transmits a request, in written form, to the user to present information relating to the price billed by the company (e.g., without limitation, to directly write-in information about the price, or to send scanned data of the bill) on the Talkroom between the user and the server 10, as a function to encourage the user to provide billing amount information from the company through the Talk with the user. At that time, the user is notified that a reward will be offered if the user presents information relating to the billed price.

When information about the billing amount is written in the Talkroom between the user and the server 10, the controller 11 transmits a reward to the user. Herein, “reward” may be in any form so long as it is some kind of benefit to the user, and it may be, for example, without limitation, points usable on a messaging application, points usable as money in other services, electronic money, virtual currency, some kind of item, a coupon or electronic coupon redeemable for an item, a service providing a lottery on the terminal, or a combination of the above. “Send points as a reward” means to add points corresponding to the reward to points associated with an identifier of the user (user ID) on a messaging application. “Send electronic money” means to add an amount of money corresponding to the reward to electronic money associated with an identifier of the user on a network. “Send virtual currency” is substantially synonymous with “send electronic money”, but it means to associate with (or add to) the user an amount of money as information serving as a cash equivalent usable only within a certain service. “Send an item” means to notify that an item will be sent to the user and to actually send the item to the user's address. “Send a coupon or electronic coupon redeemable for an item” means to transmit display information indicating that the coupon is redeemable for some kind of item. A “coupon or electronic coupon” is information (a right) that can be exchanged with an item by presenting the display information at a shop that provides that item. “Offer a service providing a lottery on the terminal” means to give the user the right to draw an electronic lot on the terminal. Herein, “electronic lot” may be for receiving some kind of prize, with examples including points usable in the messaging service provide by the server 10, some kind of electronic information (e.g., wallpaper), money, or some kind of item.

The terminal 20 accepts an input via the input/output device 23 based on an instruction from the user about information on the billing amount from the company server 40, and transmits the information to the server 10. As regards the input of information on the billing amount, the terminal may accept a price directly inputted by the user to the touch panel 231 of the input/output device 23, or may accept image information a bill photographed with the camera 234. The controller 21 of the terminal 20 transmits the information in the Talkroom with the server 10 via the communication I/F 22.

The communication I/F 22 of the terminal 20 also has a function to receive a reward transmitted from the server 10. The controller 21 may store the received reward information in the storage 28.

### {Operation}

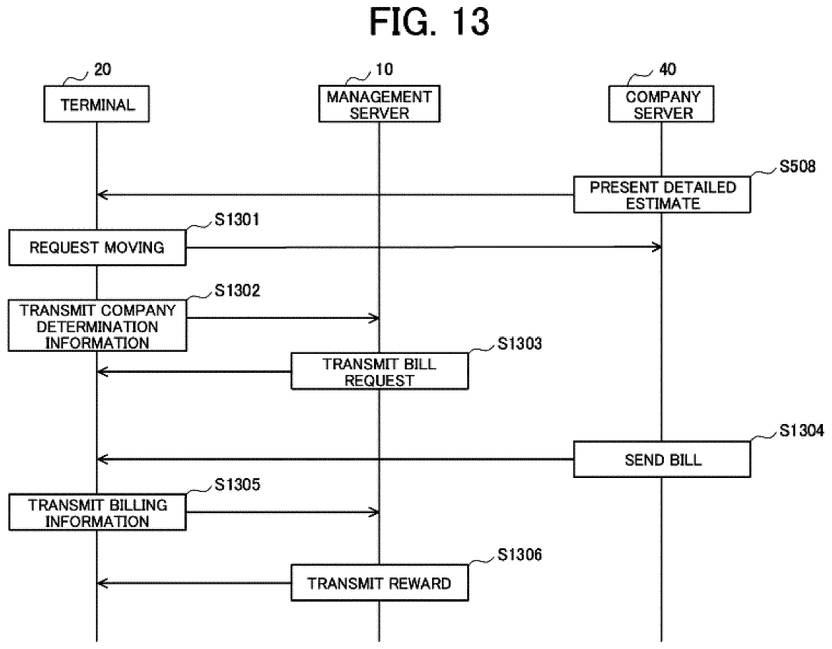

Interaction between devices in the communication system according to the second example embodiment is described using the sequence diagram illustrated in FIG. 13. FIG. 13 illustrates processes following the sequence diagram of FIG. 5, and illustrates processes following operation S508 of FIG. 5.

As illustrated in FIG. 13, if the user of the terminal 20 having received a detailed estimate is satisfied with the contents of the estimate, the user requests a service (e.g., places a moving request) to the company server 40 (operation S1301). Further, the user uses the terminal 20 to notify the determined moving company in the Talkroom with the server 10 (operation S1302).

In response to receiving the notification about the determination of a moving company, the server 10 transmits a bill request to the user, requesting transmission of the company's bill (operation S1303). For example, in the Talkroom with the terminal 20, the server 10 makes a notification requesting the user to send the bill transmitted from the company server 40 after moving, or information about the billing amount indicated by the bill, in the Talkroom.

After actually finishing moving, the company server 40 sends a bill to the terminal 20 (operation S1304). In FIG. 13, the company server 40 sends the bill to the terminal 20 in the form of electronic data, but the bill may be sent separately by post, or may be directly handed to the user. Note that operation S1303 and operation S1304 may be processed in inverse order. That is, operation S1304 may be executed first, and then operation S1303 may be executed. In some example embodiments, operation S1303 and operation S1304 may be executed concurrently.

In response to receiving a bill, the user transmits billing information via the Talkroom with the server 10 (operation S1305). Transmission of billing information may be done by directly writing the billing amount in the Talkroom, or by transmitting electronic data of the bill, or by transmitting data obtained by scanning the actual bill.

Having confirmed the billing information from the user, the server 10 transmits a desired (or alternatively, predetermined) reward to the user terminal 20 (operation S1306).

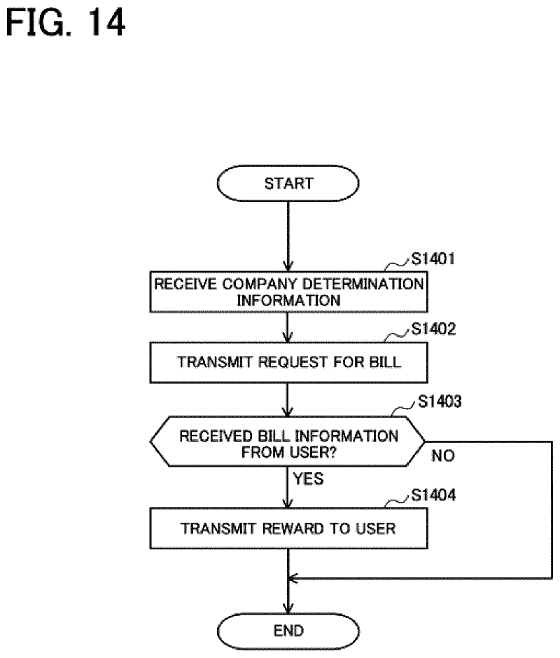

Processes at the server 10 for achieving the interaction illustrated in FIG. 13 are described using the flowchart illustrated in FIG. 14.

The communication I/F 14 of the server 10 receives company determination information from the user terminal 20 (operation S1401). The communication I/F 14 transmits the received company determination information to the controller 11.

The message processor 112 of the controller 11 having received the company determination information transmits a bill request, requesting information relating to a bill, to the Talkroom with the user (operation S1402).

Then, the controller 11 determines whether or not bill information has been received from the user (operation S1403). If bill information has been transmitted via the Talkroom with the user (YES at operation S1403), then the message processor 112 of the controller 11 transmits a reward to the user (operation S1404), and the process is ended. On the other hand, if the user has not transmitted bill information (e.g., if no bill information has been received) (NO at operation S1403), the process is ended without transmitting a reward to the user. Herein, “no bill information has been received” may refer to cases where the user indicated his/her intention not to transmit information about the bill, or to cases where no bill information have been received during a desired (or alternatively, predetermined) time from when the user received the service. The above describes the processes at the server 10.

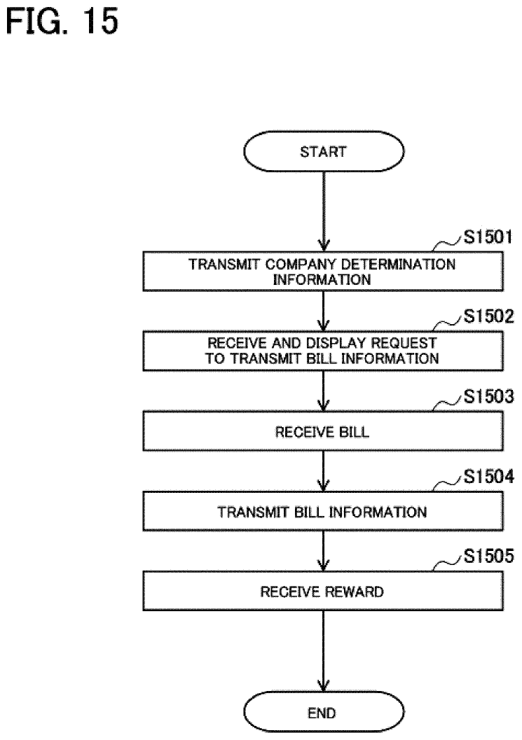

FIG. 15 is a flowchart illustrating processes at the terminal 20 for achieving the interaction in the sequence diagram of FIG. 13.

The user transmits company determination information from his/her terminal 20 to the server 10 (operation S1501). For example, without limitation, the user transmits the company determination information via the Talkroom with the server 10 by using his/her terminal 20.

In response to transmission of the company determination information, the communication I/F 22 of the terminal 20 receives a request from the server 10 to send bill information. In response to receiving the bill information transmission request from the server 10, the communication I/F 22 transmits the information to the message processor 211. The message processor 211 instructs the display processor 212 to display information in the Talkroom, showing text information indicating the received request to transmit bill information. In response to this instruction, the display processor 212 makes the display 24 display an image of the Talkroom showing the request to transmit bill information (operation S1502).

Then, the user receives a service (e.g., moving service) from the company server 40. The user terminal 20 then receives bill information from the company server 40 (operation S1503). As described above, the bill information may be received by hand or by post.

Having received the bill from the company server 40 from which the user received the service, the user transmits information relating to the billing amount indicated on the bill to the server 10 via the communication I/F (operation S1504). For example, without limitation, the user transmits the information via the Talkroom between the user and the server 10 by using his/her terminal 20.

The communication I/F 22 receives a reward transmitted from the server 10 in response to the transmission of the bill information (operation S1505), and the process is ended.

### Concrete Examples

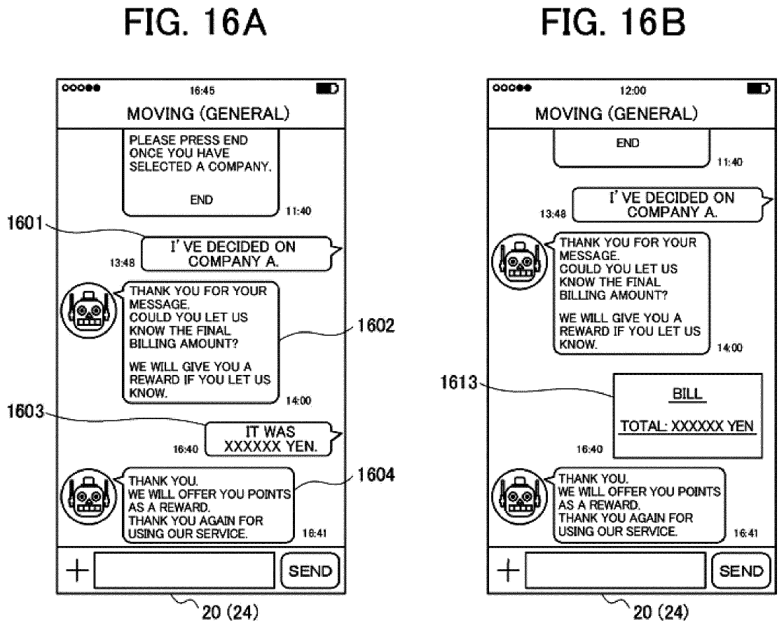

The second example embodiment will be described below by way of examples. FIGS. 16A and 16B are diagrams of screens illustrating examples of exchanging contents (e.g., messages, stamps, images, or moving images) in a Talkroom between the server 10 and the terminal 20.

FIG. 16A illustrates an example wherein the user has directly written in the billing amount. FIG. 16B illustrates an example wherein a photo of a bill (e.g., an image of a bill photographed by the user with the camera 234 of the terminal 20, or scanned data of a bill) has been pasted in the Talkroom.

As illustrated in FIG. 16A, after viewing the estimates from the various company servers 40, the user makes an agreement with a company with which he/she is satisfied. As illustrated in message 1601 of FIG. 16A, the user writes in the Talkroom that he/she has decided on a company to request service. The example of FIG. 16A shows that the user has decided on “Company A” as the service-providing company.

In response, the server 10 transmits a message requesting the user to disclose information about the price billed. FIG. 16A shows an example wherein the server 10 (or an operator thereof) has written a message requesting presentation of the final price, and indicating that some kind of reward or compensation will be offered if the user presents the billing amount, as illustrated in message 1602. The timing that the server 10 executes this message 1602 may be any time after the user has transmitted the message 1601 regarding information indicating that the user has decided on a company to request service. The timing may be, for example, immediately after transmission of message 1601, or after the service date in cases where the message 1601 from the user included information about the date when the service will be provided.

After actually receiving the service, the user writes information about the billing amount. FIG. 16A shows an example wherein the user has written that the billing amount was “XXXXXX yen” as illustrated in message 1603.

In response to the message 1603 written by the user, the server 10 writes a message 1604, informing that a reward will be sent, and then actually sends the reward.

In this way, the user exchanges the billing amount with the server 10. The difference between FIG. 16B and FIG. 16A is that an image 1613 is sent instead of the message 1603. The example of FIG. 16B is different in that image data of the bill is pasted in the Talkroom as image 1613, but the other features are the same as in FIG. 16A.

In this way, the server 10 can recognize the amount actually billed from the company server 40. In this example, information about the billing amount is directly received from the user, but in cases where, for example, the user paid the company server 40 by using transaction employing virtual money or point settlement usable in a messaging application, the server can acquire the information relating to the billing amount by referring to the payment information, without input from the user. Note that, as a condition for the server 10 to acquire billing amount information in cases where electronic transaction is performed via the server 10, it may be desirable to obtain permission from the user in advance, or to make a request in the Talkroom for permission to verify the billing amount and obtain the user's permission.

### {Batch Notification of Estimated Amounts}

In the foregoing first and second example embodiments, each company server 40 sends its estimate individually via a Talkroom created between each company server and the user. Some company servers 40, however, may send a relatively cheap estimate in a rush in an attempt to get the work. In such cases, a user who saw such a cheap estimate may make a request without waiting for estimates from other company servers 40.

In view of the above, the system may be configured such that the server 10 once collects estimates from each of the company servers 40, and collectively notifies the user about the estimated amounts once a certain number of estimates have been obtained.

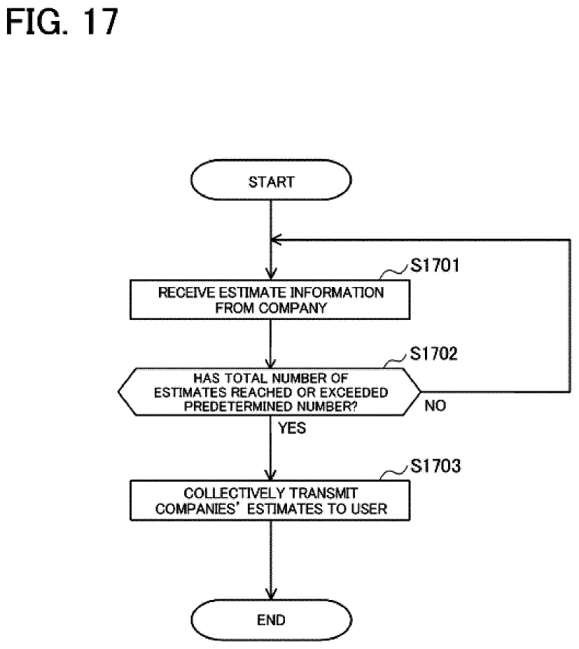

For example, the server 10 may operate as illustrated in FIG. 17. The processes illustrated in FIG. 17 are processes after receiving an estimate request from the user terminal 20 and notifying that estimates will be sent later from company servers 40.

As illustrated in FIG. 17, the communication I/F 14 of the server 10 receives, from each dealer (e.g., each company server 40) estimate information indicating an estimated amount in response to the user's estimate request (operation S1701). The communication I/F 14 transmits the received estimate information to the controller 11. The controller 11 stores the received estimate information in the storage 15 in association with the identification information indicating the respective company servers 40 that transmitted the estimate information.

In response to receiving the estimate information, the controller 11 determines whether or not the estimate information has been received from at least a desired (or alternatively, predetermined) number of company servers 40 from among the plurality of company servers 40 that are to provide estimates to the user. Stated differently, the controller 11 determines whether or not the number of pieces of estimate information that have been sent from the company servers 40 in response to the user's estimate request and that are stored in the storage 15 is equal to or greater than a desired (or alternatively, predetermined) number (operation S1702). Herein, the “desired (or alternatively, predetermined) number” may be at least two because this will allow the user to compare estimated amounts. According to some example embodiments, the number may match the total number of company servers 40 providing estimates.

If the total number of pieces of estimate information is less than the desired (or alternatively, predetermined) number (NO at operation S1702), the process returns to operation S1701, and the server goes on standby until it receives the next estimate information. If the total number of pieces of estimate information becomes equal to or greater than the desired (or alternatively, predetermined) number (YES at operation S1702), then the controller 11 compiles together the pieces of estimate information, and transmits the information to the Talkroom with the user in a manner that the estimated amounts from the respective company servers 40 can be compared (operation S1703). Herein, “compile together and transmit the estimate information” may be achieved by the server 10 directly writing the prices indicated by the respective pieces of estimate information in the Talkroom with the user, or the server successively transmitting the pieces of estimate information as-is in the Talkroom.

In this way, the server 10 can prevent a company server 40 providing an estimate from sending a cheap estimate ahead of other company servers 40 to get a request. The server 10 can also provide the user with the opportunity to consider which company server 40 he/she wants to make a request to, based on the estimated amounts.

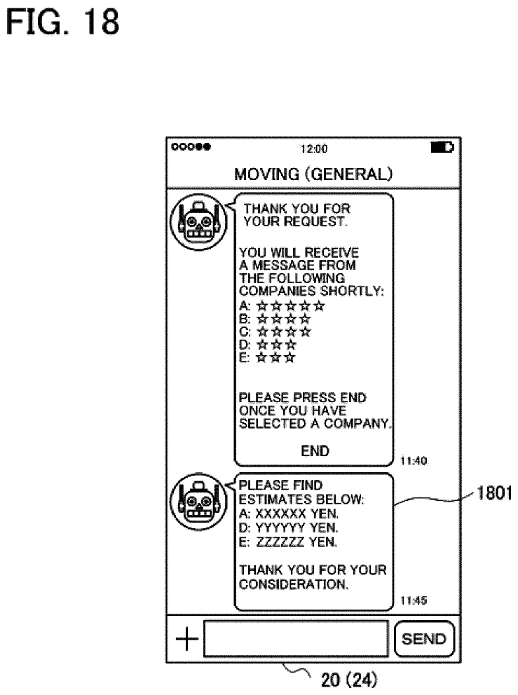

FIG. 18 is a diagram illustrating an example of a screen of a Talkroom that can be viewed by the user in response to receiving estimates from a desired (or alternatively, predetermined) number of company servers 40. In FIG. 18, it can be understood that, as illustrated in message 1801, estimated amounts from three companies, (e.g., Companies A, D and E) have been transmitted collectively to the user. The example of FIG. 18 illustrates that the respective estimated amounts are XXXXXX yen for Company A, YYYYYY yen for Company D, and ZZZZZZ yen for Company E. At this time, the names (or identification information) of the respective companies and their respective estimated amounts may be displayed in ascending (or descending) order of the companies' estimated amounts.

In FIG. 18, the server 10 makes the message 1801 and arranges the estimated amounts from a plurality of company servers 40 side by side, but the server 10 may sequentially send the estimate information sent respectively from the company servers 40 as-is.

Although not described in detail here, the mode/configuration described in the foregoing first example embodiment may be applied to the second example embodiment.

For example, interaction between the user and the server 10 using a rich menu as illustrated in FIG. 11A is applicable to the present example embodiment. For example, without limitation, in the present example embodiment, it is possible to use a rich menu including a send button for transmitting information relating to an estimated amount and a send button for transmitting information relating to a billing amount. The system may be configured such that, by pressing these send buttons, the user can, for example, designate information (data file) about an estimated amount, as well as information (data file) about a bill, stored in the storage 28 of the user terminal 20, and thereby transmit the information to the server 10. In this way, burden on the user to input information can be reduced.

Further, also in the second example embodiment, as illustrated in FIG. 11B, the user or the server 10 (or an operator thereof) may perform interaction using image information (stamps) usable in a messaging service in performing interaction relating to the estimated amount and billing amount. For example, without limitation, the server 10 may transmit image information indicating gratitude in response to transmission of billing amount information by the user in the Talkroom.

Further, along with the billing amount, the terminal 20 may transmit, to the server 10, the evaluation information including user's evaluation of the company server 40 relating to the billing amount.

### Modified Examples of Second Example Embodiment

(1) The foregoing second example embodiment describes processes up to when the server 10 transmits a reward to the terminal 20. The server 10 may, however, further execute the following processes in response to receiving information about a bill provided by a company server 40. For example, in cases where the billing amount deviates from the estimated amount by over a certain amount, the server 10 may correct the evaluation information of that company.

For example, in cases where a difference calculated by subtracting the estimated amount from the billing amount is greater than a desired (or alternatively, predetermined) amount, the controller 11 of the server 10 may correct the evaluation information of the company server 40 so as to lower the rating thereof, indicating that the billing amount is much higher than the estimated amount. In cases where a difference calculated by subtracting the estimated amount from the billing amount is smaller than a desired (or alternatively, predetermined) amount (e.g., the calculated difference indicates that the billing amount is much lower than the estimated amount and that the company bills a smaller amount than its estimate), the controller 11 of the server 10 may correct the evaluation information of the company server 40 so as to raise the rating thereof. The raising/lowering of the evaluation information can be executed by addition/subtraction in cases where the evaluation information is set as a numerical value or a level (rating). Further, it is possible to add evaluation information in written text.

(2) In the foregoing second example embodiment, the server 10 is configured to receive billing amount information from the user terminal 20, but the information may be received from the company server 40. The billing amount information may be received from both the terminal 20 and the company server 40.

(3) In the foregoing second example embodiment, the controller 11 of the server 10 goes on standby until a desired (or alternatively, predetermined) number of estimates arrive, and collectively transmit the estimates to the terminal 20 when a desired (or alternatively, predetermined) number of estimates have been received. The configuration, however, is not limited thereto. The estimates may be transmitted based on time, and not the number of estimates. For example, the controller 11 of the server 10 may measure a desired (or alternatively, predetermined) length of time (e.g., 48 hours) from when the estimate request was transmitted to the company servers 40, and, after passage of the desired (or alternatively, predetermined) time period, may transmit all pieces of estimate information that have been received up to that point to the terminal 20, regardless of the number of pieces of estimate information. In cases where the estimate information is transmitted to the terminal 20 after waiting for a desired (or alternatively, predetermined) time to pass, the server 10 may or may not collectively transmit the pieces of information in a batch.

(4) In the foregoing second example embodiment, the server 10 obtains information about a price actually billed by a company server 40 by asking the user terminal 20 to transmit information about the billing amount. The configuration, however, is not limited thereto. In cases where the server 10 offers a payment service for payment with, for example, electronic money and the terminal 20 uses that payment service to pay a company server 40, the server 10 may automatically acquire the amount paid from the terminal 20 to the company server 40 as information relating to the billing amount. In this case, it is desirable that the server 10 has obtained permission from both the terminal 20 and the company server 40 to acquire the payment amount information.

(5) In the foregoing first or second example embodiment, the controller 11 of the server 10 may predict a billing amount that may be billed from each company server 40 providing an estimate, and transmit, to the terminal 20, information about the predicted billing amount, which relates to the billing amount that has been predicted. For each company server 40, the controller 11 may store information about services provided in the past and contents (details) of those services, as well as information about the respective billing amounts, in the storage 15. The information may be stored in an external device accessible from the server 10.

For each company providing an estimate, the controller 11 acquires data including service-contents information having at least a desired (or alternatively, predetermined) degree of correlation with the contents (details) of an estimate request from the user. Then, the controller 11 may transmit the amount billed by the company server 40 when it performed the highly-correlated service, as a predicted billing amount which is a predicted value of an amount that may be billed, to a user making a new estimate request. In cases where it is possible to acquire a plurality of data having high correlation, for example, the average value may be transmitted as a predicted billing amount, which is a predicted value of an amount that may be billed, or the highest price or the lowest price, among the plurality of billing amounts, may be transmitted to the user terminal 20 as a predicted billing amount. Note, however, that the method for predicting the billing amount is not limited to the above, and various other methods may be employed. An operator of the server 10 may use a prediction method which he/she finds suitable. Another prediction method may be, for example, without limitation, to construct a learning model for each company, the model having learned billing amounts from service contents based on service contents provided in the past by that company and billing amounts billed therefor, and make the controller 11 input the user's estimate request to the learning model to calculate a predicted billing amount.

The controller 11 transmits the predicted billing amount information which has been calculated to the terminal 20 after the user makes an estimate request and after (or before) each company transmits its estimate information, but before the user actually decides on a company to request service. Then, the terminal 20 displays the predicted billing amount information which has been received on the display 24. At this time, the terminal 20 may make the display 24 display the estimate information transmitted from each company server 40 alongside the predicted billing amount as predicted by the server 10 to enable comparison. Further, information indicating that the predicted billing amount is a price predicted by the server 10 may be displayed. Further, instead of (or in addition to) the predicted billing amount, a difference between the predicted billing amount and the estimated amount may be displayed. In this way, the server 10 may provide the user with a predicted billing amount as a material for determining which company to place a service request with.

### Effects of Example Embodiment

In the foregoing second example embodiment, after receiving an estimate from a company server 40 and receiving service from that company server 40, the user of the terminal 20 may transmit, to the server 10, information about a billing amount billed from the company server 40. The server 10 may receive the information about the billing amount.

In this way, the server 10 can acquire information relating to both an estimated amount and a billing amount issued by a company server 40. Thus, the server 10 can recognize whether or not there is a deviation between the estimated amount and billing amount issued by the company server 40. For example, without limitation, in cases where there is a deviation between the estimated amount and billing amount, the evaluation (rating) of that company server 40 may be adjusted (e.g., lowered).

Further, as evaluation information, it is possible to add an evaluation in written text stating that, for example, “the actually billed amount may be higher than the estimate.” In this case, the user can acquire information relating to evaluations for more companies. Thus, the user can acquire more information that may provide grounds for actually determining a service-providing company.

Further, according to an instruction from the user, the terminal 20 may transmit an image of a bill sent from the company server 40 as photographed with the camera 234, as information relating to the price that was billed. The server 10 may receive the photographed image of the bill from the terminal 20 as information relating to the price billed by the company server 40.

In this way, the server 10 can obtain information relating to the billed amount, as a reliable evidence of the bill.

Further, in response to receiving information from the terminal 20 relating to the amount billed from the company server 40, the server 10 may transmit information relating to a reward to the terminal 20 (or the user thereof). The terminal 20 may receive the information relating to the reward transmitted from the server 10.

In this way, the server 10 can send an expression of gratitude to the terminal 20 for providing the information relating to the billing amount.

Further, the terminal 20 may make a remittance to the company server 40 via the server 10. That is, in cases where the server 10 has a function to execute exchange of money or the like via electronic commerce (e.g., system, program, or app), the server 10 can acquire the payment amount from the terminal 20 to the company server 40 as information about the billing amount.

In this way, the server 10 can acquire information about the billing amount billed from the company server 40 to the terminal 20, without receiving information relating to the billing amount from the user (e.g., without bothering the user).

Further, with reference to information about billing and service provided therefor previously by a company server 40, the server 10 may predict a billing amount that may be billed when that company actually provides service in response to a new estimate request from a user, and may transmit the predicted amount to the user terminal 20. The terminal 20 may receive information about the predicted amount, and display it on the display 24.

In this way, the terminal 20 and the server 10 can provide the user with more material for determining which company to place a service request with. This can improve the user's convenience in using the service.

Further, in cases where estimate information is received from a company server 40 before passage of a desired (or alternatively, predetermined) period of time from when the user's estimate request was sent to the company servers 40, the server 10 may not transmit the received estimate information to the terminal 20 until the desired (or alternatively, predetermined) period of time has passed. Then, after passage of the desired (or alternatively, predetermined) time, the server 10 may transmit, to the terminal 20, pieces of estimate information received from respective company servers 40 up to that point. Thus, the terminal 20 may receive one or more pieces of estimate information for the first time after passage of a desired (or alternatively, predetermined) time from when the estimate request was made.

Further, the server 10 may be configured such that, even if the server has received a piece of estimate information from a company server 40, it does not transmit the estimate information to the terminal 20 until a desired (or alternatively, predetermined) number of pieces of estimate information are received from the company servers 40, and may be configured such that the server 10 collectively transmits the estimate information to the terminal 20 once at least a desired (or alternatively, predetermined) number of pieces of estimate information have been received.

With this configuration, the server 10 can temporarily keep the estimated amount information, and can thereby increase the possibility that the terminal 20 can compare estimated amounts from a plurality of company servers 40, to which an estimate has been requested, the first time the terminal receives the information. Thus, it is possible to reduce the possibility of user dissatisfaction against the server 10 that may arise if the user makes a request to a company server 40 that has sent its estimate information in a rush by setting the estimate cheaper than the actual billing amount.

The terminal 20 may be configured to display image information wherein pieces of estimate information from respective company servers 40, as transmitted from the server 10, are collectively displayed. The information may be displayed as text information and not as an image.

In this way, the user can easily compare the estimated amounts provided by the respective companies.

Further, the terminal 20 may receive pieces of estimate information from a plurality of company servers 40 transmitted collectively from the server 10, and display the pieces of information on the display 24 according to an order as indicated by the estimated amounts in the estimate information.

In this way, the user can recognize which company gave the lowest estimate or highest estimate at a glance.

Further, the terminal 20 may transmit information about a negotiation (transaction) between the user and a company server 40 to the server 10. The information indicating transaction may be a message (text information) or an image showing contents of the transaction.

In this way, by using the terminal 20, the user can transmit, to the server 10, information relating to transaction performed with the company server 40 by using a message or image. The server 10 can obtain information about transaction performed between the user and the company server 40, and can thus, for example, evaluate the company server 40.

Further, after receiving service from the company server 40, the user may transmit user evaluation information indicating an evaluation of the company, which is the user's own impression regarding at least the billing amount, from the terminal 20 to the server 10. This evaluation may be information indicating an evaluation of a person in charge at the company server 40 who actually did the work, or both pieces of information.

In this way, the terminal 20 can transmit, to the server 10, the user's own evaluation of the company or the person in charge after receiving the service. In response to receiving the evaluation, the server 10 can reflect the user's evaluation onto the evaluation information when presenting the evaluation information to other users in the future, and can thereby provide information relating to evaluations even closer to real-time.

Further, the terminal 20 may display a list indicating various companies (e.g., a list of company names or a list of corresponding Talkrooms). The terminal 20 may accept selection from the user regarding whether or not to disclose the user's detailed information to each of the companies making estimates. The terminal 20 may terminate communication with a company server 40 to which the user has determined not to disclose detailed information.

In this way, communication with a company that has become unnecessary to the user can be terminated, and therefore, the user does not have to communicate with that company in the future. Thus, for example, the user will not be subjected to sales activities from a company with which the user is not performing transaction.

Further, the terminal 20 can perform negotiations individually via respective Talkrooms created by the server 10 between the user and the respective companies.

In this way, the user can negotiate with each company without letting the company know about interactions with other companies and the situation thereof, and can thus perform transaction to his/her advantage.

Further, the terminal 20 may display information about each company server 40, with which to perform transaction, via a rich menu in a Talkroom between the terminal and the server 10.

In this way, information can be provided according to different formats/modes for respective users each enjoying service provided by the server 10.

### Third Example Embodiment

The first and second example embodiments described systems enabling the selection of a company server 40 more suitable to a user when the user wishes to receive a service. A third example embodiment describes a configuration that benefits the company server 40 as a function provided by the server 10. Note that, as in the second example embodiment, the configuration of various devices is in common with the first example embodiment. So, features that are different from the first and second example embodiments will be described below, and features that are the same will be omitted from explanation.

### {Configuration}

The server 10 according to the third example embodiment transmits information beneficial also to the company servers 40, and not only the user. For example, at the time of an estimate request, if there seems to be good compatibility between a company server 40 and the user's request, the server 10 makes a notification to that effect. Herein, “good compatibility” may or may not mean, for example, that a company server 40 can provide work matching the user's preference, or that one of the areas of specialty of a company server 40 matches the user's request. “A company server 40 matches the user's preference” may mean, for example, that the user's preference or indication, for, for example, price, quality, speed, the way the service-provider works (e.g., the service provider works while communicating actively with the user, or the service provider works quietly with a craftsmanly attitude), or friendliness, matches a characteristic of a company server 40 when that company provides its service. Herein, “price” indicated by the user may include an indication that a high level of cost performance is preferred. “Quality” indicated by the user may include an indication that high quality (e.g., good service (quality)) is preferred. “Speed” indicated by the user may include an indication that the user places importance on work speed. In other words, the user's preference may include information indicating which of the preferences, e.g., price, quality, or speed, should be prioritized.

To achieve such a configuration, the controller 11 of the server 10 may include, in the stored user information 200, information other than those illustrated in FIG. 2, such as the user's preferences or hobbies. Including such information may further facilitate the selection of a company server 40 having good compatibility with the user. However, even if such information is not included, it is possible to determine the compatibility only from the user information 200 illustrated in FIG. 2, based on a match with the fields/areas of specialty of a company server 40.

Further, the controller 11 of the server 10 also performs matching in consideration of relevance between a user who has made an estimate request and other users who made other estimate requests, to provide information beneficial to the company server 40. “Matching in consideration of relevance with other users” means, for example, to perform matching based on the degree (strength) of relevance (e.g., the strength of correlation) between a new estimate request from a user and requests from other users, in order for the company server 40 to actually provide its service. For example, without limitation, in cases where the company server 40 is a moving company, it may be judged that there is high (strong) relevance in cases where there is a match between the areas from and to which the respective users are moving, or there is a match between the moving origins. Further, it is possible to determine that there is even higher relevance if there is a match between the request dates (or desired dates for moving). If there is a high relevance, it is conceivable that there is a high possibility the user will actually request service from the company server 40.

To achieve this configuration, the controller 11 of the server 10 has a function to perform matching between the user's request and company servers 40. For example, in response to receiving an estimate request from a user, the controller reads out user information about the user who made the estimate request from the storage 15. The controller also reads company information 2100, which is information indicating characteristics of each of the company servers 40 stored in the storage 15. The controller 11 then judges the degree of compatibility based on the user information about the user who made the estimate request and the characteristics of each of the companies indicated by the company information 2100. For example, without limitation, it is possible to calculate a correlation value between correlating items in the user information and the company information, and judge whether or not there is good compatibility depending on whether or not the correlation value exceeds a desired (or alternatively, predetermined) threshold.

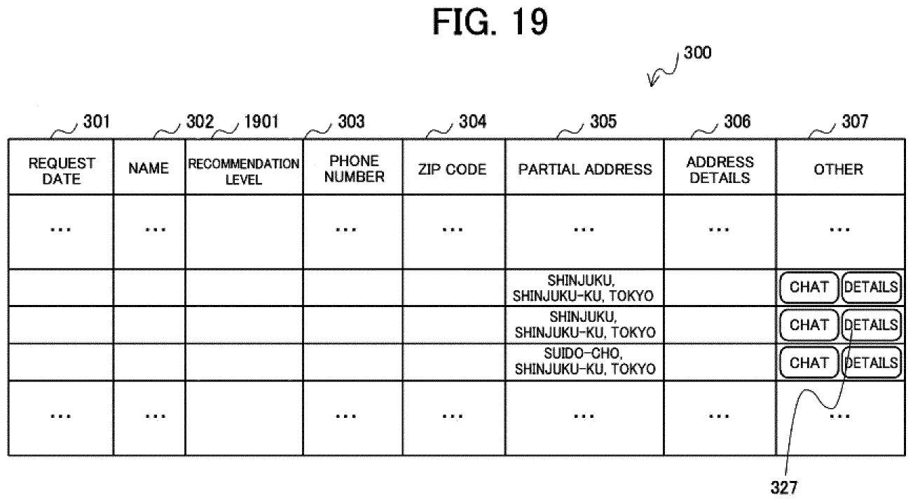

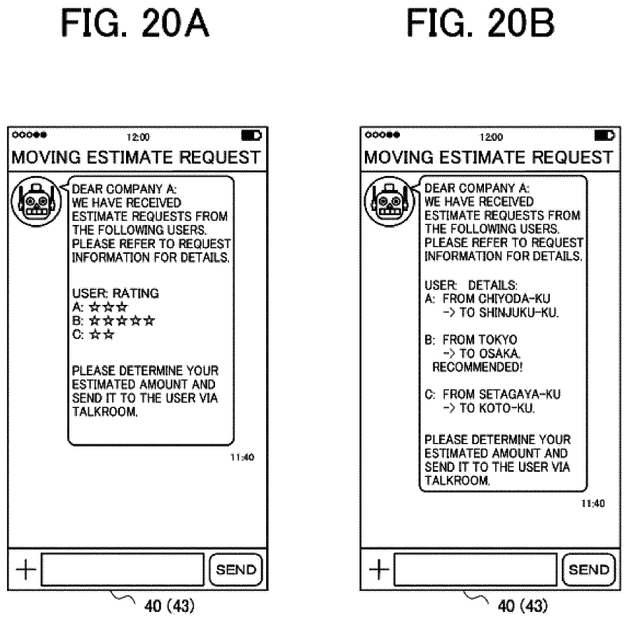

Each company server 40 receives request information 300 from the server 10, and displays the received request information 300 on its display 43. A user judged by the server 10 as having good compatibility may be displayed according to a format different from other users to indicate that the user is recommended. In other words, the user has a high possibility to make a request (transaction), or text information indicating that the user is recommended may be displayed. Information about a user recommended by the server 10 to the company server 40 may be displayed in a Talkroom between the server 10 and the company server 40. Whether or not a user is recommended is information indicating evaluation of a user from the perspective of the company server 40. FIG. 19 illustrates an example wherein a recommendation level 1901 is included as an example of including evaluation information about a user in the request information 300. The recommendation level 1901 is information indicating the level (degree) that each user is recommendable to each company server 40 from the perspective of the server 10, and is evaluation information about each corresponding user from the perspective of the company server 40. In the example illustrated in FIG. 19, the recommendation level is indicated as a numerical value, but is may be ranked in alphabetical order, such as A, B, or C, or may be a binary value simply indicating whether the user is recommended or not. By viewing the request information 300 as illustrated in FIG. 19, an operator of the company server 40 can determine users to whom estimates are to be transmitted (e.g., users who can be judged as being providable with the company's service). Whether or not a user is recommended may be notified from the server 10 to the company server 40 in the Talkroom between the server 10 and the company server 40. For example, information indicating the evaluation of users may be provided to each company server 40 as illustrated in FIGS. 20A and 20B. FIG. 20A is an example displaying the evaluations (ratings) of users by stars in a Talkroom, and is a diagram illustrating an example of a screen of a Talkroom displayed on the display 43 of the company server 40. FIG. 20B is a diagram illustrating an example of a screen of a Talkroom wherein an indication of recommendation is directly shown as an evaluation of a user. As illustrated in FIGS. 19, 20A and 20B, the company server 40 can make the display 43 display evaluation information indicating evaluations of users transmitted from the server 10.

### [{Data}

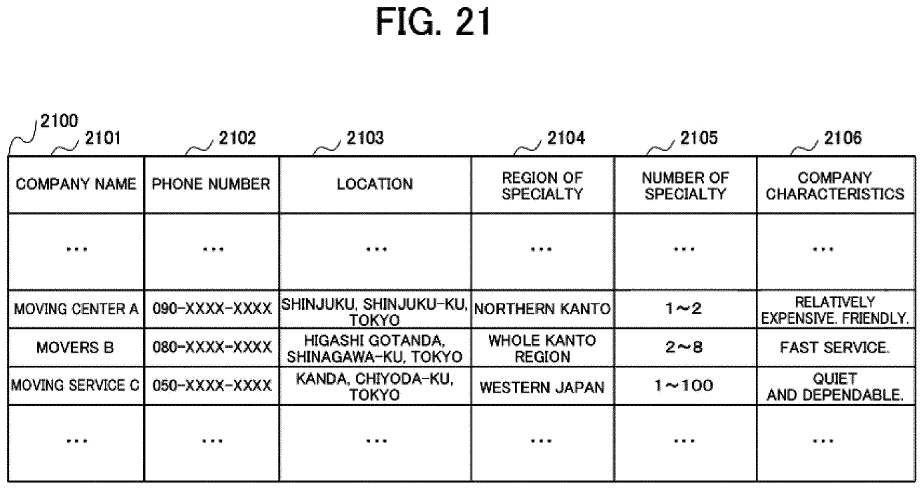

FIG. 21 is a conceptual data diagram illustrating an example of company information 2100 which is data used for judging a match (compatibility) between company servers 40 and users, indicating characteristics of respective company servers 40. The company information 2100 may be stored in the storage 15, or may be stored in an external device accessible from the server 10.

As illustrated in FIG. 21, the company information 2100 is, for example, information in which company name 2101, phone number 2102, location 2103, region of specialty 2104, number of specialty 2105, and company characteristics 2106 are correlated. Information other than the company name 2101 may or may not be included in the company information 2100. Note that the company information 2100 illustrated in FIG. 21 is an example wherein the companies are moving companies. For other types of businesses, other information items corresponding to the business type may be included.

The company name 2101 is identification information for uniquely identifying the corresponding company servers 40. Instead of, or in addition to, the company name, other identifiers of the respective company servers 40 may be used.

The phone number 2102 is information indicating the phone number used for contacting the company indicated by the corresponding company name 2101.

The location 2103 is information indicating the location (address) of the company indicated by the corresponding company name 2101.

The region of specialty 2104 is information indicating a region (area) in which the company, which is indicated by the corresponding company name 2101, specializes when providing its service. In cases where the company server 40 is a moving company, the “region of specialty” may be, for example, information indicating a region (area) that the company is good at providing moving services, e.g., an area near the company, an area near a garage where the company's moving truck is parked, or an area with which the truck driver is familiar.

The number of specialty 2105 is information indicating the number of people (on the user side) that the company, which is indicated by the corresponding company name 2101, is good at handling when providing its service. In cases where the company server 40 is a moving company, the “number of specialty” may be information indicating what kind of household, including how many members, the company is good at handling when providing its moving service (e.g., a single-member household, a four-member household, or an extended family household).

The company characteristics information 2106 is information, other than those described above, that indicates characteristics (attributes) of the company indicated by the corresponding company name 2101. The company characteristics 2106 may be any information so long as it is about the company's characteristics, and may include, for example, the level of cost performance, service quality, service provision speed, or the company's attitude toward providing its service. The example of FIG. 21 shows the company characteristics 2106 as written text to facilitate understanding, but it may be expressed as information wherein, for each company, information indicating each company's rating (level) is associated with each of various types of items (e.g., without limitation, cost performance, quality, and speed).

In the example of FIG. 21, it can be understood that the company for which the company name 2101 is “Movers B” has the phone number “080-XXXX-XXXX”, the company's address is in “Higashi Gotanda, Shinagawa-ku, Tokyo”, its region of specialty is “whole Kanto region”, its “number of specialty” (the number of people the company is good at handling) is from 2 to 8 people, and its motto is “fast service”.

The server 10 judges compatibility with a user making a request (whether or not to recommend the user) by mainly using information such as the region of specialty 2104, the number of specialty 2105, and the company characteristics 2106. Note that the server 10 may judge compatibility by using all the information, or may judge compatibility without using all the information.

### {Operation}

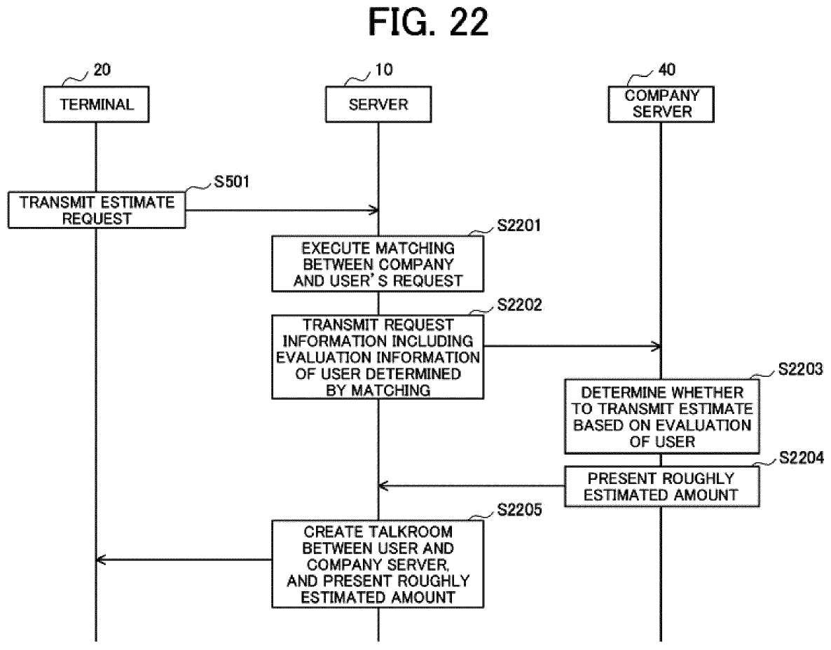

FIG. 22 is a sequence diagram illustrating interaction between various devices when the server 10 introduces a user estimated as having good compatibility with a company server 40, and illustrates a flow from when a user makes an estimate request to when the user receives a rough estimate from a company server 40.

Operations S501 and S504 illustrated in FIG. 22 are the same as operations S501 and S504 in the sequence diagram of FIG. 5, and thus explanation thereof is omitted.

In response to receiving an estimate request from a user terminal 20, the server 10 executes matching between company servers 40 and the user's wishes indicated in the estimate request (operation S2201). That is, the server 10 specifies company servers 40 that may have good compatibility with the user's request. Stated differently, the server 10 specifies recommendable users that may have good compatibility with each company server 40. Herein, “specifying a recommendable user” may include at least either specifying whether a user is recommendable from the perspective of the company server 40, or specifying an index indicating how much recommendable a user is to the company.

The server 10 transmits, to the company server 40, request information including evaluation information of a user determined by matching (operation S2202). The request information may or may not include requests from a plurality of users. At this time, the server 10 may or may not notify the user terminal 20 that roughly estimated amounts will be notified later from company servers 40.

In response to viewing the request information transmitted from the server 10, an operator of the company server 40 judges whether or not to accept the user's request and determines whether or not to send an estimate (operation S2203). In response to determining that an estimate is to be sent to the user, a roughly estimated amount is calculated from the contents of the user's estimate request. The company server 40 transmits, to the server 10, the calculated estimated amount and information rendering identifiable which user's estimate request the calculated estimated amount is for (operation S2204).

In response to receiving, from the company server 40, the estimated amount and the information indicating which request the estimated amount is for, the server 10 creates a Talkroom between the company server 40 and the user who made the request, and transmits the estimated amount from the company server 40 to the terminal 20 by presenting it on the Talkroom (operation S2205). The processes of operations S2204 and S2205 correspond to the process of operation S504 in FIG. 5. In this way, the company server 40 (or an operator thereof) can judge, for the requests from one or more users, whether or not to issue an estimate (e.g., to provide service) based on the evaluation of each user. Note that, in FIG. 22, as illustrated in operations S2204 and S2205, the estimated amount information is transmitted from the company server 40 to the terminal 20 via the server 10, but the information may be transmitted directly from the company server 40 to the terminal 20.

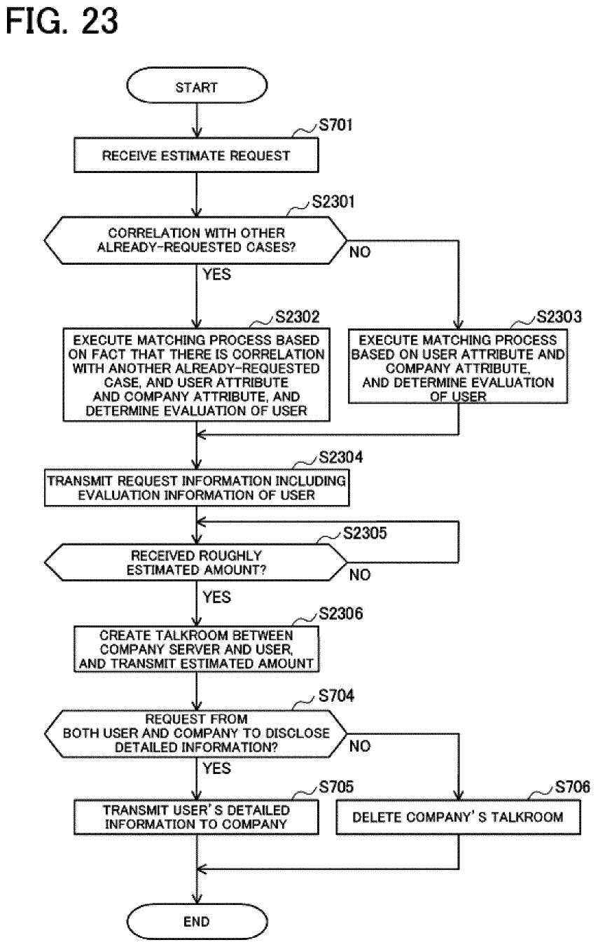

Next, processes at the server 10 for achieving the processes illustrated in FIG. 22 are described using FIG. 23. FIG. 23 is a flowchart illustrating operations for achieving the processes of operations S2201 to S2205 of FIG. 22, the processes being incorporated into the flowchart of FIG. 7. Therefore, explanation about the processes already described using FIG. 7 is simplified, and features different from those of FIG. 7 will be described in detail.

As illustrated in FIG. 23, the server 10 receives an estimate request from the terminal 20 (operation S701).

The controller 11 judges whether or not there is correlation with other already-requested cases (operation S2301). From the contents of the estimate request presented in operation S701, the controller 11 judges whether or not there is correlation based on the degree of matching with contents of other estimate requests made by other users. If it is judged that there is correlation with another already-requested case (YES at operation S2301), the controller 11 executes matching based on the contents indicated by the user information 200 and the contents indicated by the company information 2100, and also determines an evaluation of the user from the perspective of the company server 40, the evaluation being revised upward as a result of judging that there is correlation with another already-requested case (operation S2302). Then, the process proceeds to operation S2304. For example, without limitation, in cases where preference regarding cost performance, preference regarding service quality, and preference regarding service provision speed are set as characteristics of each user, and evaluation regarding cost, evaluation regarding service quality, and evaluation regarding service provision speed are set as the company characteristics 2106 of each company server 40, the server judges whether or not each item satisfies the user's preference and also calculates the degree of matching in cases where the user's preference is satisfied, and integrates the evaluation. In this way, an evaluation of each user from the perspective of the company server 40 can be determined. In cases of simply determining whether or not to recommend a user, the determination may be made based on whether or not the evaluation exceeds a desired (or alternatively, predetermined) threshold. In another example, whether or not the company server 40 satisfies each of the user's characteristics (preferences) may be judged one by one, and the number of items satisfied may be employed as the evaluation of the user from the perspective of the company server 40. On the other hand, if the controller 11 judges that there is no correlation with other already-requested cases (NO at operation S2301), the controller 11 executes matching based on the contents indicated by the user information 200 and the contents indicated by the company information 2100, and determines an evaluation of the user from the perspective of the company server 40 (operation S2303). The controller 11 transmits the request information 300, including the evaluation information about the user, to the company server 40 via the communication I/F 14 (operation S2304).

The controller 11 judges whether or not the communication I/F 14 received information about a roughly estimated amount from the company server 40 (operation S2305). The controller 11 goes on standby until it receives information about a roughly estimated amount (NO at operation S2305). If the communication I/F 14 receives information about a roughly estimated amount from the company server 40 (YES at operation S2305), the controller 11 creates a Talkroom between the company server 40 and the user who made the estimate request corresponding to the estimated amount. The controller 11 then transmits, on the Talkroom, the estimated amount information received from the company server 40 (operation S2306). Then, the process proceeds to operation S704. The processes from operation S2301 to operation S2305 are executed instead of the processes from operation S702 to operation S703 of FIG. 7.

### {Concrete Examples of Matching Process}

A processing method with which the server 10 looks for correlation between estimate requests is described in detail below for an example where the company server 40 is a moving company.

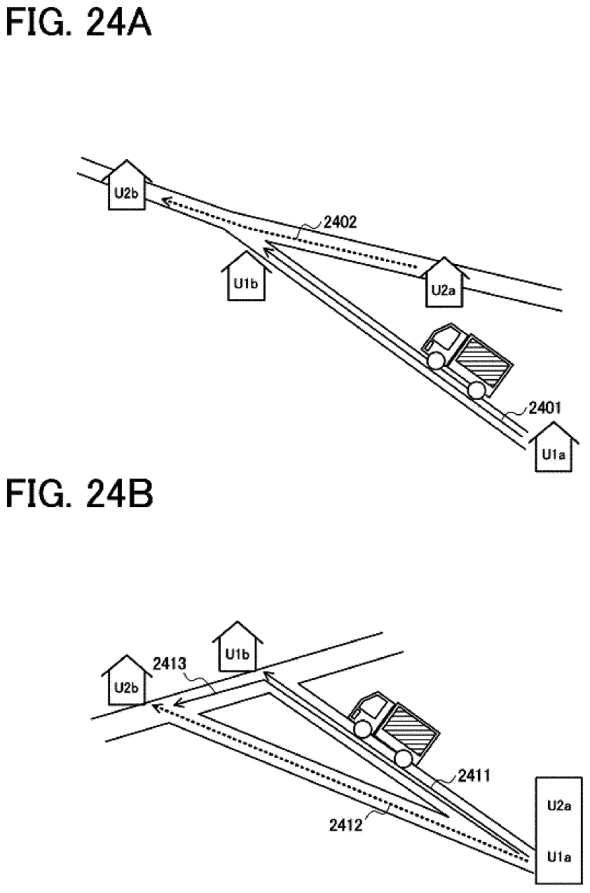

FIG. 24A illustrates a situation wherein user U1 has already made an estimate request, involving route 2401 from U1a to U1b, to company A. As regards this estimate request for route 2401, the user U1 may decide to request the company A to undertake the work. It is assumed that, in this situation, a new estimate request has been sent in from user U2 to the server 10.

Herein, it is assumed that the server 10 is able to recognize, from the contents of the estimate request from the user U2 that the request relates to a moving request indicated by route 2402 from U2a to U2b. The controller 11 of the server 10 calculates a correlation value between route 2401 and route 2402. For example, the controller 11 calculates the proximity between route 2401 and route 2402 in terms of their locations and route shapes. If, for example, the correlation value is higher than a desired (or alternatively, predetermined) threshold and the desired moving dates coincide, it is determined that the estimate request from the user U2 matches with company A, which is the company to which the user U1's estimate request has been transmitted. That is, the controller 11 determines to transmit the estimate request from the user U2 to the company A.

Similarly, FIG. 24B illustrates a situation wherein user U1 has already made an estimate request, involving route 2411 from U1a to U1b, to company A. As regards this estimate request for route 2411, the user U1 may decide to request the company A to undertake the work. It is assumed that, in this situation, a new estimate request has been sent to the server 10 from user U2, indicated by route 2412 from U2a to U2b.

Herein, if the controller 11 of the server 10 judges that the user U2's request has the same starting point as the user U1's request and that the respective directions of route 2411 and route 2412 are in the same direction to at least a certain extent, the controller 11 determines that the estimate request from the user U2 matches with company A, which is the company to which the user U1's estimate request has been transmitted. That is, the controller 11 determines to transmit the estimate request from the user U2 to the company A. In such cases, the controller 11 may determine that there is a match by, for example, without limitation, calculating the respective vectors of route 2411 and route 2412, and determining whether a correlation value between the vectors is equal to or greater than a desired (or alternatively, predetermined) threshold. An example of a method for calculating a correlation value may be to calculate the inner product of the vector of route 2411 and the vector of route 2412, and if the inner product is equal to or greater than a desired (or alternatively, predetermined) value, it is considered that the correlation value is equal to or greater than a threshold, thereby determining that there is a match. As illustrated in FIG. 24B, in cases where two requests have the same starting point, it is conceivable, for example, to select a route that allows moving of both cases via the destination of one of the requests, to thereby cut costs, as illustrated by route 2413, on condition that both users U1 and U2 give permission. In such cases, the billing amounts to both users U1 and U2 can be reduced, so the estimated amounts to both users U1 and U2 can also be reduced, thus increasing the possibility of getting the request(s).

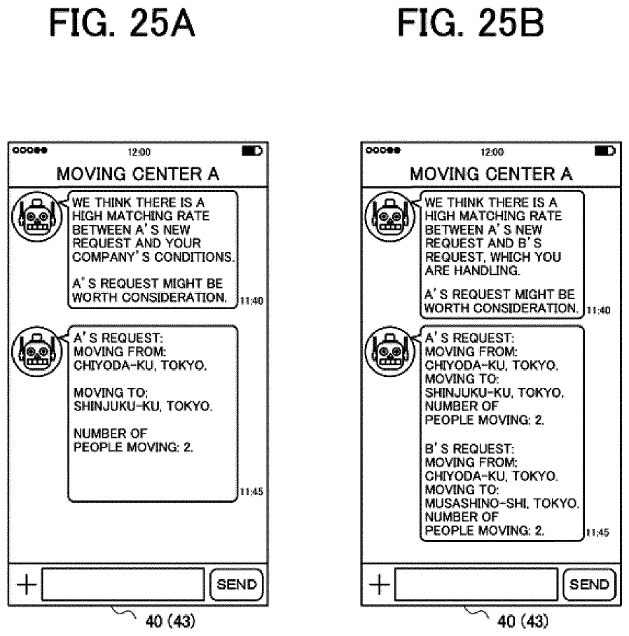

FIG. 25 is a diagram of a screen, illustrating an example of a Talkroom between the server 10 and the company server 40, and is a diagram of a screen viewable with a device of the company server 40. FIG. 25A illustrates an example of a message transmitted from the server 10 to the company server 40 in response to performing the process of operation S2303 in FIG. 23 (e.g., in cases where the new estimate request has no correlation with other previous estimate requests).

As illustrated in FIG. 25A, the server 10 transmits, to the company server 40, a message indicating that there is a request from a user A and that the request has a high matching rate with user B who has already made a request to the company server 40. At this time, as illustrated in FIG. 25A, the message may or may not be transmitted so as to display the user A's request together with the user B's request. The message may only show one of the requests.

FIG. 25B illustrates an example of a message transmitted from the server 10 to the company server 40 in response to performing the process of operation S2303 in FIG. 23 (e.g., in cases where the new estimate request has correlation with another previous estimate request). As illustrated in FIG. 25B, the server 10 transmits, to the company server 40, a message indicating that there is a request from a user A and that the contents of the estimate request from the user A has a high matching rate with the company server 40 (e.g., that the request has good compatibility). At this time, as illustrated in FIG. 25B, the message may display the contents of the request from the user A, who is the new requester, together with the contents of the request from user B, who is the requester of a previous estimate request having correlation. By also displaying the contents of the user B's request, which is a request made previously, an operator of the company server 40 can easily compare it with the contents of the new request from the user A.

By obtaining the information as illustrated in FIG. 25 from the server 10, the company server 40 can enjoy the advantage that decision-making is facilitated regarding reducing the estimated amount and/or whether or not to accept the request.

In situations as illustrated in FIG. 24, from the company's perspective, the moving work itself will be easier (in terms of, e.g., arrangement of pickup of belongings from the moving origin, or arrangement of vehicles) because the relocation is from a nearby place to a nearby place, and thus, there is a possibility that the number of processes can be reduced compared to handling completely separate cases. In such cases, the company A may be able to reduce the costs for both users U1 and U2, and may be able to accommodate cheaper estimates. By sending cheaper-than-usual estimates to both users U1 and U2, it is possible to increase the possibility of accepting requests from both users U1 and U2.

Note that, although not described in detail here, the configuration described in the foregoing first example embodiment may or may not be applied to the third example embodiment. For example, interaction between the user and the server 10 using a rich menu as illustrated in FIG. 11A, is applicable to the present example embodiment by replacing the user with the company server 40. For example, without limitation, in the present example embodiment, it is conceivable to display, as a rich menu, a menu including buttons respectively indicating users from which estimate requests have been sent from the server 10. For example, without limitation, these buttons may or may not be buttons for starting a Talk with the respective users.

Further, also in the third example embodiment, in exchanging information about a user who is making an estimate request, the company server 40 (or an operator thereof) or server 10 (or an operator thereof) may or may not perform interaction using image information (stamps) as illustrated in FIG. 11B. For example, without limitation, in a Talk with a user, the company server 40 may use image information indicating that it has the intention of reducing the price for a service it is providing. This may make it easier for the user to place a request.

Further, the company server 40 may transmit, to the server 10, evaluation information indicating an evaluation of a user after providing its service or based on interactions with the user in the course of (including before) providing its service. The server 10 may or may not store the company's evaluation of the user in the user information 200 as metadata. The company's evaluation of the user may or may not be reflected onto future calculations of matching rates between the company server 40 and users.

### Effects of Example Embodiment

In response to an estimate request from a user, the controller 11 of the server 10 may specify a company having good compatibility based on the contents of the estimate request. The controller 11 may specify a company having good compatibility with the user's estimate request based on the contents of the estimate request, and information about each company (which is an example, without limitation, of “information relating to a company”) or information indicating characteristics of each company (which is an example, without limitation, of “information relating to a company”). The controller 11 of the server 10 may then transmit the user's estimate request to the company server 40 via the communication I/F 14, and also transmit information indicating that the user is recommended to the company server 40.

Further, the display 43 of the company server 40 may display the received request information, and, in cases where there is an indication that the user who made the request is recommended, may also display this according to a display format showing that the user is recommended.

In this way, the server 10 can provide the company server 40 with information about a recommended user, and thus, trust can be gained from the company server 40. This can also increase the possibility being able to introduce, to the user, a company suitable for the user, and thus, trust can be gained also from the user.

From the perspective of the company server 40, it is possible to determine whether to adjust the estimated amount in order to get a request in a field that the company specializes in and/or from a user having good compatibility. In order to provide service in a field that the company specializes in or to provide service to a user with good compatibility, the company server 40 may provide a somewhat cheaper estimate to attract and acquire the user, and then the company can provide highly-satisfying service that meets the user's wishes, and can thereby obtain a high evaluation from the user, thus increasing the possibility of gaining new customers (users).

Further, based on the degree of matching or degree of correlation between the contents of the user's estimate request and company information (characteristics) of each company server 40, the controller 11 may transmit, to the company server 40, information indicating whether or not the user is recommended.

In this way, the server 10 can introduce, to the company server 40, users having a higher possibility of making a request. Thus, from the perspective of the company server 40, it is possible to keep the estimate low to the extent possible in order to gain customers, and also provide service that is highly satisfying to the user, which will lead to improving the company's evaluation (reputation).

Further, the server 10 may transmit, to the company server 40, request information 300 in which requests from a plurality of users have been compiled, and may attach, to the request information 300, information indicating whether or not a user is recommended for the company. Herein, “information indicating whether or not a user is recommended” may be information based on whether or not the user has a high possibility of performing transaction with the company server 40.

In this way, the company server 40 can receive estimate requests from a plurality of users and also identify which user should be prioritized from among those requests, and interact with that user with priority.

Further, the storage 15 of the server 10 may store user information 200, and the user information 200 may include information that relates to a user but does not render each user identifiable and that renders the contents of each request understandable to a certain extent (e.g., without limitation, of “first information”), and information that renders each user identifiable (an example, without limitation, of “second information”).

The aforementioned information that relates to a user but does not render each user identifiable and that renders the contents of each request understandable to a certain extent (e.g., without limitation, of “first information”) allows the company server 40 to calculate a roughly estimated amount and convey the amount to the user. This configuration, in turn, allows the user to know a rough estimate of the service he/she wants to receive, without disclosing information that renders the user identifiable (e.g., without limitation, of “second information”). By not disclosing information that renders the user identifiable, the user will not be subjected to advertisements and sales activities from various companies/dealers in the future.

Further, the information that relates to the user and renders the user identifiable (e.g., without limitation, of “second information”) allows the company server 40 to create a detailed estimate, and the user can use the detailed estimate as a material for determining whether or not to place the request (i.e., whether or not to receive service).

At the initial stage of the estimate request, the server 10 transmits the contents of the user's request to the company server 40, but does not transmit information that renders the individual user identifiable (e.g., without limitation, of “second information”). The information that renders the individual user identifiable (e.g., without limitation, of “second information”) may be transmitted in cases where there is permission from the user.

The server 10 can transmit the user's estimate request to the company server 40 without revealing the user's personal information, and can transmit the user's personal information to the company server 40 only if there is permission from the user. Thus, the server 10 can gain trust from the user.

Further, in determining a user to recommend to a company, the controller 11 of the server 10 may use information about transactions performed by the company in the past. That is, in cases where a new estimate request sent from the server 10 to a company server 40 has high correlation with the contents of a previous estimate request, the user of the new request is introduced as recommended, because there is a possibility that the company server 40 is good at handling the request, or can reduce the man-hours for providing the service in cases where there is a high relevance between the requests.

In this way, the server 10 can provide highly reliable information to the company server 40.

Further, with respect to estimate requests from users, when the server 10 judges whether there is a user to recommend to a company server 40, the server 10 may determine a recommended user by using information such as the field of specialty of the company server 40 or characteristics thereof (e.g., without limitation, the region of specialty 2104, the number of specialty 2105, and/or the company characteristics 2106).

Because a recommended user is determined by using information indicating the field of specialty or characteristics of the company server 40 in providing service, it is possible to increase the possibility that the user will actually place the request, and also, the company can work efficiently by providing service in a field of specialty of the company server 40.

Further, in a moving task indicated in an estimate request from a user, the server 10 can judge whether or not the user who made the estimate request is recommendable to the company server 40 based on information about the moving origin area and the moving destination area and information indicating a region of specialty of the company (e.g., information indicating a region in which the company can provide service).

In this way, the server 10 can improve user satisfaction by providing the user with service in a region in which the company server 40 specializes. Further, the server 10 can provide high-quality service, because a more suitable user can be introduced to the company server 40.

Further, the company server 40 may transmit, to the server 10, information relating to negotiation (transaction) performed between the company server 40 and a user. The server 10 can receive the information for the negotiation (transaction). The information relating to transaction may be a message (text information) or an image showing the contents of the transaction.

In this way, the company server 40 can transmit, to the server 10, information relating to negotiation (transaction) performed with the user, and thus, the server 10 can obtain the aforementioned information. Therefore, the server 10 can verify whether a fair transaction was performed between the user and the company server 40, and can also evaluate both the user and the company server 40 based on the contents of the transaction. This evaluation may or may not be reflected to the user information 200 and/or the company information 2100. In cases where the evaluation is reflected, in a future matching process between a user and a company server 40, matching can be achieved using the latest information about the user or the company.

### {Others}

Some example embodiments of the present disclosure have been described above according to various examples with reference to the drawings, but it should be noted that a person skilled in the art can easily make various modifications and/or alterations based on the present disclosure. Thus, such modifications and/or alterations are within the scope of the present disclosure. For example, without limitation, various functions included in the various means and steps can be rearranged in a manner causing no logical contradiction, and a plurality of means or steps can be combined into a single means/step, or a single means/step can be divided. Further, features described in various example embodiments or modified examples may be employed in combination as appropriate.

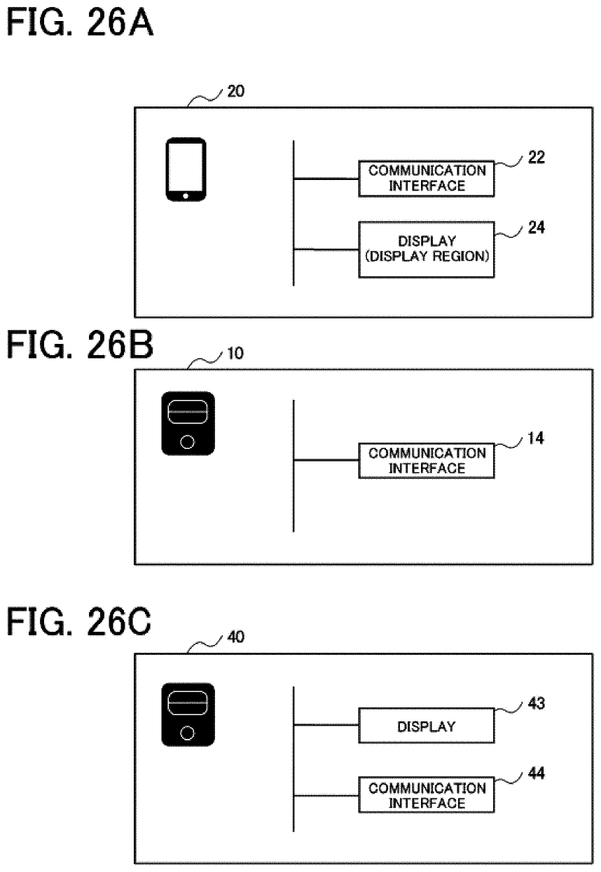

Instead of the configuration illustrated in FIG. 1, the configurations of the terminal 20, the server 10, and the company server 40 described in the foregoing example embodiments may be configured as illustrated in FIG. 26.

As illustrated in FIG. 26A, the terminal 20 may be constituted by a communication interface 22 and a controller 21. The communication interface 22 of the terminal 20 transmits user information (estimate request) to the server 10, receives information about company servers 40 for performing transactions and evaluation information indicating evaluations of the company servers from the server 10, and makes the display 24 display the company servers and the evaluation information.

Further, as illustrated in FIG. 26B, the server 10 may be constituted by a communication interface 14. The communication interface 14 of the server 10 receives user information (estimate request) from a user terminal 20, and transmits information about company servers 40 for performing transactions and evaluation information indicating evaluations of the company servers. In this way, the server 10 can provide information beneficial to the user in determining which company to place a service request with, and can therefore gain the user's trust. Further, the user can obtain beneficial material for determining which company to place a service request with.

Further, as illustrated in FIG. 26A, the terminal 20 may be constituted by a communication interface 22 and a display 24. The communication interface 22 transmits user information (estimate request), and in response thereto, receives, from the server 10, information relating to an estimated amount from a company server 40. The display 24 of the terminal 20 displays the received information relating to the estimated amount on its display region. The user of the terminal 20 receives a bill from the company server 40 with which he/she placed a request and from which he/she actually received service. According to an input from the user, the communication interface 22 of the terminal 20 transmits, to the server 10, information about the bill from the company server 40.

Further, as illustrated in FIG. 26B, the server 10 may be constituted by a communication interface 14. The communication interface 14 receives user information (estimate request). The communication interface 14 transmits the estimate request to a company server 40, and in response thereto, receives an estimated amount from the company server 40. The communication interface 14 of the server 10 transmits the estimated amount to the terminal 20. The communication interface 14 then receives, from the terminal 20, information relating to the billing amount from the company server 40 that provided service. In this way, the server 10 can obtain information about both the estimated amount and the billing amount, and can thus verify whether or not there is a deviation between the estimated amount and the billing amount.

Further, as illustrated in FIG. 26B, the server 10 may be constituted by a communication interface 14. The server 10 receives user information (estimate request), determines a company server 40 to which the estimate request is to be transmitted, and transmits the estimate request to the company server 40 that has been determined. As regards a user recommendable to the company server 40, the server 10 also transmits, to the company server 40, information that rates the user as recommended.

Further, as illustrated in FIG. 26C, the company server 40 may be constituted by a display 43 and a communication interface 44. The company server receives, from the server 10, an estimate request from a user and also information that rates the user as recommended. The display 43 displays the contents of the estimate request and the information indicating that the user is recommended. In this way, the server 10 can provide information beneficial to the company server 40, and the company server 40 can obtain a material for determination in choosing which requests to accept.

According to some example embodiments, the server 10 is engaged between the terminal 20 of a user, who generates an estimate request, and respective company servers 40, which are supposed to provide estimates, and is configured to provide a company list to the terminal 20 based on information previously collected in advance (e.g., evaluation information related to an evaluation of the at least one candidate company from among the companies of the company servers 40). Thus, the user of the terminal 10 may receive requested estimates from at least some of the company servers 40 via the server 10 while consuming less computing and communicating resources thereof.

It should be understood that example embodiments described herein should be considered in a descriptive sense only and not for purposes of limitation. While some example embodiments have been particularly shown and described, it will be understood by one of ordinary skill in the art that variations in form and detail may be made therein without departing from the spirit and scope of the claims.

What is claimed is:

1. A display method for a terminal including a processor and configured to transmit/receive information to/from a server, the display method comprising:
transmitting, by the terminal, first information including information of a user of the terminal to the server;
receiving, by the terminal, candidate information related to at least one candidate company and evaluation information related to an evaluation of the at least one candidate company from the server, the candidate information being based on the first information; and
displaying, on a display region of the terminal, the candidate information based on the evaluation information.

2. The display method according to claim 1, further comprising:
transmitting, by the terminal, second information for the transaction to the server, the second information including information of the user and being different from the first information, the second information to be transmitted to a company selected by the user among the candidate information displayed on the display region.

3. The display method according to claim 1, wherein
the displaying displays the candidate information related to the at least one candidate company on the display region by differing a display mode thereof based on the evaluation information.

4. The display method according to claim 3, wherein
the evaluation information indicates an order in which to display the at least one candidate company on the display region.

5. The display method according to claim 3, wherein
the at least one candidate company includes a first candidate company and a second candidate company, and
the displaying displays the second candidate company having a poorer evaluation than the first candidate company based on the evaluation information on the display region.

6. The display method according to claim 3, further comprising:
displaying at least a portion of the evaluation information of the at least one candidate company on the display region based on the evaluation information.

7. The display method according to claim 2, further comprising:
transmitting, to the server, user evaluation information by the user as to the company selected by the user.

8. The display method according to claim 1, further comprising:
receiving, from the server, personal information of a person in charge at the at least one candidate company.

9. The display method according to claim 8, further comprising:
receiving personal evaluation information of the person in charge from the server.

10. The display method according to claim 1, further comprising:
receiving, from the server, company information of a company recommend for the user among the at least one candidate company based on preference information related to a preference of the user.

11. The display method according to claim 1, further comprising:
transmitting, to the server, transaction information related to the transaction with the at least one candidate company.

12. The display method according to claim 11, wherein
the transaction information is a message.

13. The display method according to claim 11, wherein
the transaction information is image information for performing the transaction with the at least one candidate company.

14. The display method according to claim 1, further comprising:
transmitting, to the server, evaluation of the user as to a candidate company selected by the user among the at least one candidate company.

15. The display method according to claim 1, wherein
the displaying displays a plurality of pieces of candidate information related to a plurality of candidate companies on the display region; and
the display method further includes terminating communication of transaction information related to the transaction with a first company other than a second company selected by the user, among the plurality of candidate companies displayed on the display region.

16. The display method according to claim 15, wherein
the transaction information is information related to a message, and
the communication is executable between the user and a corresponding one of a plurality of company servers associated with the plurality of candidate companies by the message.

17. The display method according to claim 15, wherein
the displaying displays the plurality of pieces of candidate information on the display region, the plurality of pieces of candidate information being changeable on a terminal-to-terminal basis.

18. A terminal configured to transmit/receive information to/from a server, the terminal comprising:
a memory configured to a program; and
one or more processors configured to execute the program such that the one or more processors are configured to cause the terminal to,
transmit first information including information of a user of the terminal to the server,
receive candidate information related to at least one candidate company and evaluation information related to an evaluation of the at least one candidate company from the server, the candidate information being based on the first information, and
display the candidate information based on the evaluation information.

19. A non-transitory computer readable medium storing a program that, when executed by a processor, causes a terminal including the processor and configured to transmit/receive information to/from a server to perform a display method, the method comprising:
transmitting, by the terminal, first information including information of a user of the terminal to the server;
receiving, by the terminal, candidate information related to at least one candidate company and evaluation information related to an evaluation of the at least one candidate company from the server, the candidate information being based on the first information; and
displaying, on a display region of the terminal, the candidate information based on the evaluation information.
